(19) United States
(12) Patent Application Publication
(10) Pub. No.: US 2026/0210299 A1
(43) Pub. Date: Jul. 23, 2026

(54) GAS TURBINE ENGINE HAVING COMPOSITE FAN BLADES

(71) Applicant: General Electric Company, Evendale, OH (US)

(72) Inventors: Arthur William Sibbach, Boxford, MA (US); Gary Willard Bryant, JR., Loveland, OH (US)

(21) Appl. No.: 19/572,969

(22) Filed: Mar. 20, 2026

Related U.S. Application Data
(63) Continuation-in-part of application No. 19/362,542, filed on Oct. 20, 2025.
Application No. 19/362,542 is a continuation of application No. 18/909,259, filed on Oct. 8, 2024, now Pat. No. 12,473,863.
Application No. 18/909,259 is a continuation-in-part of application No. 18/603,773, filed on Mar. 13, 2024, now Pat. No. 12,473,832.

(51) Int. Cl. F02C 7/36

(52) U.S. Cl. CPC F02C 7/36; F05D 2220/36; F05D 2260/4031

(57) ABSTRACT

A gas turbine engine includes: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio during operation of the gas turbine engine in a cruise operating mode; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8.

### CROSS-REFERENCE TO RELATED APPLICATIONS

This application is a continuation-in-part of U.S. application Ser. No. 19/362,542 filed Oct. 20, 2025, which is a continuation of U.S. application Ser. No. 18/909,259, filed Oct. 8, 2024 (now U.S. Pat. No. 12,473,863), which is a continuation-in-part application of U.S. application Ser. No. 18/603,773 filed Mar. 13, 2024 (now U.S. Pat. No. 12,473,832). Each of these applications is hereby incorporated by reference in their entireties.

### FIELD

The present disclosure relates to a gas turbine engine having composite fan blades.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extract energy from the combustion gases for powering the compressor(s), as well as for producing useful work to propel an aircraft in flight. The turbomachine is mechanically coupled to the fan for driving the fan during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a close-up view of a blade of the gas turbine engine of FIG. 1 in accordance with an exemplary aspect of the present disclosure.

FIG. 3 is a table of example engines of the present disclosure.

FIG. 4 is a cross-sectional view of a gas turbine engine in accordance with another exemplary aspect of the present disclosure.

FIG. 5 is a partly schematic isometric view of a turbofan in an aircraft engine for powering an aircraft in flight.

FIG. 6 is an axial sectional view through the turbofan portion of the engine illustrated in FIG. 5 and taken along line 2-2.

FIG. 7 is a forward-facing-aft elevational view of the turbofan illustrated in FIG. 5 and taken along line 3-3.

FIG. 8 is a top planiform view of two adjacent fan blades illustrated in FIG. 7 and taken generally along line 4-4 in conjunction with a corresponding flowchart.

FIG. 9 is a forward-facing-aft elevational view, like FIG. 7, of a turbofan in accordance with another embodiment.

FIG. 10 is a top planiform view of two adjacent fan blades in the turbofan illustrated in FIG. 9 and taken along line 6-6.

FIG. 11 is a graph showing blade solidity plotted against percent radius for an exemplary fan.

FIG. 12 is a graph showing a ratio of blade solidity to relative Mach number plotted against percent radius.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The phrases “from X to Y” and “between X and Y” each refers to a range of values inclusive of the endpoints (i.e., refers to a range of values that includes both X and Y).

The term “turbomachine” refers to a machine including one or more compressors, a heat generating section (e.g., a combustion section), and one or more turbines that together generate a torque output.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine.

The term “disk loading” refers to an average pressure change across a plurality of rotor blades of a rotor assembly, such as the average pressure change across a plurality of fan blades of a fan.

As used herein, the term “rated speed” with reference to a gas turbine engine refers to a maximum rated speed of the gas turbine engine. For example, in an engine certified by the Federal Aviation Administration (“FAA”), the rated speed refers to a rotation speed of the engine during the highest sustainable and continuous power operation in the certification documents, such as a rotational speed of the gas turbine engine when operating under a maximum continuous operation.

The term “cruise operating mode” (or “cruise condition”) refers to the condition of a gas turbine engine utilized to power an aircraft while operating at a cruise speed when the aircraft levels after climbing to a specified altitude associated with cruise flight. A gas turbine engine may operate at a cruise speed that is from 50% to 90% of a rated speed, such as from 70% to 80% of the rated speed. As used herein, the term “cruise flight” refers to a phase of flight in which an aircraft levels in altitude after a climb phase and prior to descending to an approach phase. In most flight envelopes, the cruise operating mode is exemplified by the operating mode of the gas turbine engine at a midpoint of the particular flight envelope based on a total fuel burn for the flight envelope (i.e., when the gas turbine engine has burned 50% of the total fuel burn for that gas turbine engine during the flight operation).

In various examples, cruise flight may take place at a cruise altitude up to approximately 65,000 feet (ft.). In certain examples, cruise altitude is between approximately 28,000 ft. and approximately 45,000 ft. In yet other examples, cruise altitude is expressed in flight levels (FL) based on a standard air pressure at sea level, in which cruise flight is between FL280 and FL650. In another example, cruise flight is between FL280 and FL450. In still certain examples, cruise altitude is defined based at least on a barometric pressure, in which cruise altitude is between approximately 4.85 psia and approximately 0.82 psia based on a sea-level pressure of approximately 14.70 psia and sea-level temperature at approximately 59 degrees Fahrenheit. In another example, cruise altitude is between approximately 4.85 psia and approximately 2.14 psia. It should be appreciated that, in certain examples, the ranges of cruise altitude defined by pressure may be adjusted based on a different reference sea-level pressure and/or sea-level temperature.

The term “thrust rating” for a gas turbine engine refers to a maximum amount of thrust the gas turbine engine can generate when operating at the rated speed during standard day operating conditions (i.e., sea level under standard temperature and pressure conditions).

As used herein, the term “fan pressure ratio” as it relates to a plurality of fan blades of a fan, refers to a ratio of an air pressure immediately downstream of the fan blades during operation of the fan to an air pressure immediately upstream of the fan blades of the fan during operation of the fan.

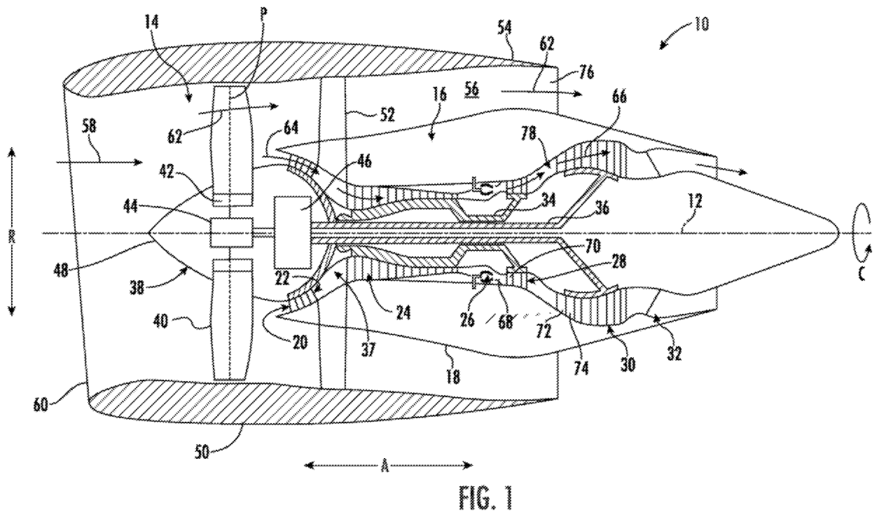

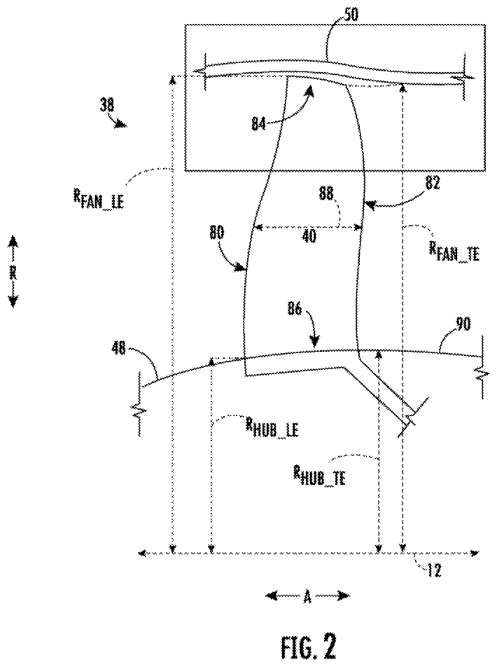

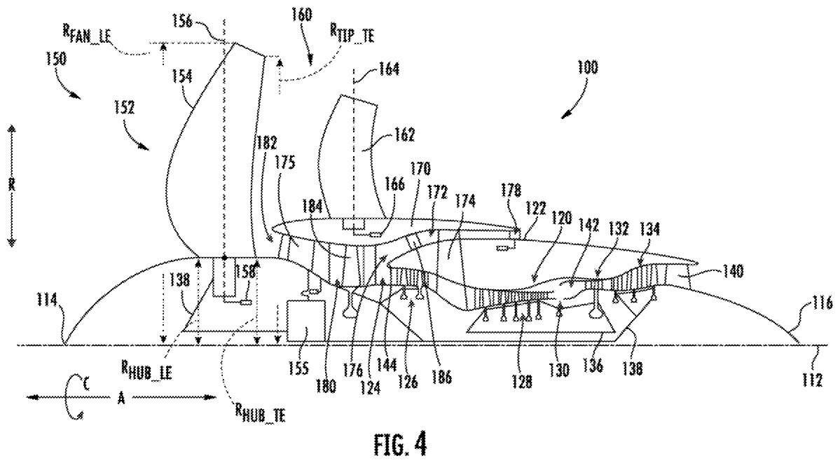

The term “bypass passage” refers generally to a passage with an airflow from a fan of the gas turbine engine that flows over an upstream-most ducted inlet to a turbomachine of the gas turbine engine. In a ducted gas turbine engine, the bypass passage is the passage defined between an outer nacelle (surrounding the fan of the gas turbine engine) and one or more cowls inward of the outer nacelle (e.g., a fan cowl, a core cowl or both if both are present; see, e.g., FIGS. 1 and 2). In an unducted gas turbine engine, the bypass passage refers to an open sided passage (i.e., not explicitly defined by structure such as an outer nacelle) where airflow from the fan passes over an upstream-most inlet to the turbomachine (e.g., inlet 182 to inlet duct 180 in FIG. 4), defined at least in part by a primary fan outer fan area, which refers to an area defined by an annulus representing a portion of the fan located outward of an inlet splitter at the upstream-most inlet to the turbomachine (e.g., inlet splitter of the fan cowl 170 in the embodiment of FIG. 4). An airflow through the bypass passage of a ducted or an unducted engine refers to all of the airflow from the fan that is not provided through the upstream-most inlet to the turbomachine.

The term “bypass ratio” refers to a ratio in a gas turbine engine of a mass flowrate of an airflow from a primary fan through a bypass passage to a mass flowrate of an airflow that passes through the engine's upstream-most ducted inlet. For example, in the embodiment of FIGS. 1, and 4 discussed below, the bypass ratio refers to a mass flowrate of an airflow through the bypass passage (e.g., from a fan 38, 152 that flows over an outer casing 18 or a fan cowl 170) to a mass flowrate of an airflow from the fan 38, 152 that flows through the engine inlet 20, 182. The bypass ratio may be defined during operation of the gas turbine engine in a cruise operating mode.

As used herein, the term “composite material” refers to a material produced from two or more constituent materials, wherein at least one of the constituent materials is a non-metallic material. Example composite materials include polymer matrix composites (PMC), ceramic matrix composites (CMC), and metal matrix composites (MMC).

As used herein, polymer matrix composites or “PMC” refers to a class of materials that include a polymer resin matrix and fibers that are stronger than the matrix, stiffer than the matrix, or both. The fibers may be a variety of materials, nonlimiting examples of which include carbon (e.g., graphite) fibers, glass (e.g., fiberglass) fibers, polymer (e.g., Kevlar®) fibers, basalt fibers, ceramic fibers (e.g. silicon carbide or alumina) and metal fibers. Resins for PMC matrix materials can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermoplastic resins include nylons, thermoplastic polyesters, polyaryletherketones, and polycarbonate resins. Specific examples of high performance thermoplastic resins that have been contemplated for use in aerospace applications include polyetheretherketone (PEEK), polyetherketoneketone (PEKK), polyetherimide (PEI), and polyphenylene sulfide (PPS). In contrast, once fully cured into a hard rigid solid, thermoset resins do not undergo significant softening when heated but, instead, thermally decompose when sufficiently heated. Notable examples of thermoset resins include epoxy, bismaleimide (BMI), polyesters, vinylesters, phenolics, and polyimide resins.

PMC materials are produced in various forms for different types for manufacturing. PMC manufacturing may be generally classified into two types: (1) prepreg layup where the operators start with materials where the fibers are preimpregnated with resin usually in thin layers which may be placed in a mold and cured to form the part; and (2) infusion where dry fibers are assembled into a preform shape and resin is infused or injected into the dry preform. There are also many subvariants of these two approaches.

As used herein, metal matrix composites or “MMC” refer to a class of materials that include a metallic matrix material reinforced with a secondary phase to improve one or more mechanical properties relative to the unreinforced metal material. The metal matrix may include titanium-based alloys (e.g., alpha, alpha-beta, beta titanium alloys, etc.), aluminum-based alloys, and/or alloys based on another metal. The reinforcement phase may include, for example, ceramic particulates, whiskers, or fibers, such as silicon carbide, alumina, or boron-containing reinforcements, dispersed within or embedded in the metal matrix. In certain embodiments, the MMC material may be selected to provide an improved specific strength, stiffness, impact resistance, or fatigue performance as compared to monolithic metallic fan blade materials, while remaining compatible with fan blade size, weight, and/or operational loading requirements.

Prepregs may be unidirectional fibers impregnated with resin or fabrics with fibers in multiple directions (e.g., woven fabrics, braids, non-crimp fabrics, uniweave fabrics) impregnated with resin and are typically 0.002 inches (in) to 0.050 in thick. Prepregs may come in wide rolls where the manufacturer cuts ply shapes, stack the cut ply shapes into the mold and cure to the make the final shape. Prepregs may be slit into narrower widths (e.g., ⅛ in to 12 in) and applied to a mold using automated fiber placement (AFP), then cured to create a final geometry. Prepregs may also be slit and chopped into small chips (e.g., 1 in×2 in, ½ in×1 in, 1 in×1 in), dropped randomly into a mold and cured to make a part.

For infusion, the dry preform may be produced in various ways. Layers of dry woven fabric, braid, and/or non-crimp fabric may be stacked together into a shape. Fibers may be woven into a final shape using 3D weave to create the preform. The resin may also be introduced in various ways. The resin may be introduced via vacuum assisted transfer molding (VARTM) where the dry preform is enclosed in a vacuum bag under vacuum and the resin is introduced into the dry preform under vacuum pressure. Resin transfer molding (RTM) may be used where the preform is placed into a closed mold and the resin is injected into the preform under pressure. As will be appreciated, these are all examples and non-limiting.

As used herein, ceramic-matrix-composite or “CMC” refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al2O3), silicon dioxide (SiO2), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al2O3), silicon dioxide (SiO2), aluminosilicates such as mullite, or mixtures thereof), or mixtures thereof.

Generally, a gas turbine engine includes a fan and a turbomachine, with the turbomachine rotating the fan to generate thrust. The turbomachine includes a compressor section, a combustion section, a turbine section, and an exhaust section and defines a working gas flowpath therethrough. With a gas turbine engine, and in particular with a high-bypass gas turbine engine, the gas turbine engine further defines a bypass ratio characterizing a ratio of a mass flowrate of airflow over the turbomachine to a mass flowrate of airflow through the working gas flowpath (more particularly defined above).

In order to provide high levels of thrust in a relatively efficient manner, certain gas turbine engines includes a relatively large fan. The inventors of the present disclosure sought out to design a gas turbine engine with a fan having an increased efficiency for a desired overall thrust output of the gas turbine engine.

Conventionally, fan blades are formed of a metal material, which generally provides for desirably thin and light fan blades. In some designs, the thickness of the fan blades drives a hub radius for the fan, which in turn affects an overall size of the fan, as a larger hub radius leads to a larger fan radius for a given thrust design point. While forming the fan blades out of metal is a cost effective manufacturing method that is widely used, the inventors found that a size of the fan blades may be limited with such construction due to the mechanical properties of the metal being used.

In particular, the inventors found that by forming fan blades of the fan out of a composite material, a size of the fan blades could be increased (both in radial length and chord length), as the composite material provides improved strength characteristics over certain metal materials traditionally used for fan blade design. This increase in size, the inventors found, allowed for a reduced fan pressure ratio for a given thrust design point of the gas turbine engine. More specifically, by forming the fan blades out of the composite material, the inventors designed the fan to have a lower solidity and lower fan blade count for the given thrust design point of the gas turbine engine as a result of the increased size of the fan blades.

Conventional design has indicated against such a change in fan blade composition, as forming the fan blades out of composite materials generally results in thicker fan blades, which can be challenging at the hub. However, the inventors found that the lower solidity and lower fan blade count allowed for the fan designed by the inventors to unexpectedly have a lower hub radius (particularly at the leading edge of the fan blades), improving efficiency of the fan at the hub, and allowing for overall shorter fan blades as the fan blades can “start” at a closer radial distance to a centerline of the gas turbine engine.

Further, the inventors of the present disclosure found that by including a reduction gearbox, a rotational speed of the fan may be reduced, further reducing the fan pressure ratio of the fan. While slowing the fan blades down too much can result in a stall at the fan during certain operations, by increasing the size of the fan blades, as is allowed through use of the composite fan blades, the inventors found that the fan may still provide for the desired mass flowrate of airflow thereacross to provide the desired thrust output.

In particular, the inventors discovered, unexpectedly, in the course of designing a gas turbine engine having a fan with composite fan blades, that the costs associated with inclusion of a fan with composite fan blades can be overcome by the aeronautical efficiency benefits to the fan in at least certain designs, contrary to previous thinking and expectations. In particular, the inventors discovered during the course of designing several gas turbine engines having fans with composite fan blades of varying thrust classes and aeronautical efficiency requirements (including the configurations illustrated and described in detail herein), a relationship exists among a leading edge tip radius of a fan blade of the fan, a leading edge hub radius of the fan, a trailing edge tip radius of the fan blade of the fan, and a trailing edge hub radius of the fan, whereby including a fan with composite fan blades in accordance with one or more of the exemplary aspects described herein may result in a net benefit to the overall gas turbine engine design. Notably, the leading edge and trailing edge hub radii (for given leading edge and trailing edge tip radii) are driven by, and correlate to, a solidity and fan blade count of the fan, as lower leading edge and trailing edge hub radii (for given leading edge and trailing edge tip radii) require a fan with a lower solidity and a lower fan blade count.

As briefly noted above, previous thinking was to form fan blades out of metal which avoids the costly process of manufacturing components using composite materials. Manufacturing components out of composite materials is either very labor intensive or requires significant upfront automation design costs. The inventors unexpectedly found that by forming the fan blades out of a composite material, the updated designs of the fan that are enabled result in gas turbine engines with aeronautical efficiency improvements that outweighed the challenges associated with manufacturing the fan blades using composite materials.

In particular, with a goal of arriving at an improved gas turbine engine capable of providing an improved aeronautical efficiency, the inventors proceeded in the manner of designing gas turbine engines having a fan (with composite fan blades) with various leading edge tip radii, leading edge hub radii, trailing edge tip radii, and trailing edge hub radii; checking an operability and aeronautical efficiency characteristics of the designed gas turbine engines; redesigning the gas turbine engines to vary the noted parameters based on the impact on other aspects of the gas turbine engines; rechecking the operability and aeronautical efficiency characteristics of the redesigned gas turbine engines; etc. during the design of several different types of fans with composite fan blades, including the fans with composite fan blades described herein, which are described below in greater detail.

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine, sometimes also referred to as a “turbofan engine.” As shown in FIG. 1, the gas turbine engine 10 defines an axial direction A (extending parallel to a longitudinal centerline 12 provided for reference), a radial direction R, and a circumferential direction C extending about the longitudinal centerline 12. In general, the gas turbine engine 10 includes a fan section 14 and a turbomachine 16 disposed downstream from the fan section 14.

The exemplary turbomachine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft 34 (which may additionally or alternatively be a spool) drivingly connects the HP turbine 28 to the HP compressor 24. A low pressure (LP) shaft 36 (which may additionally or alternatively be a spool) drivingly connects the LP turbine 30 to the LP compressor 22. The compressor section, combustion section 26, turbine section, and jet exhaust nozzle section 32 together define a working gas flowpath 37.

For the embodiment depicted, the fan section 14 includes a fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 further includes a power gear box 46, and the fan blades 40, disk 42, and pitch change mechanism 44 are together rotatable about the longitudinal centerline 12 by LP shaft 36 across the power gear box 46. The power gear box 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk 42 is covered by rotatable front hub 48 of the fan section 14 (sometimes also referred to as a “spinner”). The front hub 48 aerodynamically contoured to promote an airflow through the plurality of fan blades 40.

Additionally, the exemplary fan section 14 includes an annular fan casing or outer nacelle 50 that circumferentially surrounds the fan 38 and/or at least a portion of the turbomachine 16. It should be appreciated that the nacelle 50 is supported relative to the turbomachine 16 by a plurality of circumferentially-spaced outlet guide vanes 52 in the embodiment depicted. Moreover, a downstream section 54 of the nacelle 50 extends over an outer portion of the turbomachine 16 so as to define a bypass airflow passage 56 therebetween.

During operation of the gas turbine engine 10, a volume of air 58 enters the gas turbine engine 10 through an associated inlet 60 of the nacelle 50 and fan section 14. As the volume of air 58 passes across the fan blades 40, a first portion of air 62 is directed or routed into the bypass airflow passage 56 and a second portion of air 64 as indicated by arrow 64 is directed or routed into the working gas flowpath 37, or more specifically into the LP compressor 22. The ratio between the first portion of air 62 and the second portion of air 64 is commonly known as a bypass ratio. A pressure of the second portion of air 64 is then increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, which supports operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, which supports operation of the LP compressor 22 and/or rotation of the fan 38.

The combustion gases 66 are subsequently routed through the jet exhaust nozzle section 32 of the turbomachine 16 to provide propulsive thrust.

Simultaneously, the pressure of the first portion of air 62 is substantially increased as the first portion of air 62 is routed through the bypass airflow passage 56 before it is exhausted from a fan nozzle exhaust section 76 of the gas turbine engine 10, also providing propulsive thrust. The HP turbine 28, the LP turbine 30, and the jet exhaust nozzle section 32 at least partially define a hot gas path 78 for routing the combustion gases 66 through the turbomachine 16.

It should be appreciated, however, that the exemplary gas turbine engine 10 depicted in FIG. 1 is by way of example only, and that in other exemplary embodiments, the gas turbine engine 10 may have other configurations. For example, although the gas turbine engine 10 depicted is configured as a ducted gas turbine engine (i.e., including the outer nacelle 50, also referred to herein as a turbofan engine), in other embodiments, the gas turbine engine 10 may be an unducted gas turbine engine (such that the fan 38 is an unducted fan, and the outlet guide vanes 52 are cantilevered from the outer casing 18; see, e.g., FIG. 4; also referred to herein as an open rotor engine). Additionally, or alternatively, although the gas turbine engine 10 depicted is configured as a variable pitch gas turbine engine (i.e., including a fan 38 configured as a variable pitch fan), in other embodiments, the gas turbine engine 10 may alternatively be configured as a fixed pitch gas turbine engine (such that the fan 38 includes fan blades 40 that are not rotatable about a pitch axis P).

Referring now to FIG. 2, a close-up view is provided of the fan 38 of the gas turbine engine 10 of FIG. 1, and in particular of a fan blade 40 of the fan 38 of the gas turbine engine 10 of FIG. 1. The fan blade 40 generally defines a leading edge 80, a trailing edge 82, an outer tip 84 along the radial direction R, a base 86 along the radial direction R, and a chord 88 from the leading edge 80 to the trailing edge 82.

Further, it will be appreciated that the fan 38 defines a leading edge (LE) fan radius RFan_LE of the fan blade 40, a trailing edge (TE) fan radius RFan_TE of the fan blade 40, a leading edge hub radius RHub_LE of the fan 38, and a trailing edge hub radius RHub_TE of the fan 38. The leading edge fan radius RFan_LE of the fan blade 40 is a measure along the radial direction R from the longitudinal centerline 12 of the gas turbine engine 10 to the outer tip 84 of the fan blade 40 at the leading edge 80. The trailing edge fan radius RFan_TE of the fan blade 40 is a measure along the radial direction R from the longitudinal centerline 12 of the gas turbine engine 10 to the outer tip 84 of the fan blade 40 at the trailing edge 82. The leading edge hub radius RHub_LE of the fan 38 is a measure along the radial direction R from the longitudinal centerline 12 of the gas turbine engine 10 to the base 86 of the fan blade 40 at the leading edge 80 (where the leading edge 80 meets the spinner/front hub 48). The trailing edge hub radius RHub_TE of the fan 38 is a measure along the radial direction R from the longitudinal centerline 12 of the gas turbine engine 10 to the base 86 of the fan blade 40 at the trailing edge 82 (where the trailing edge 82 meets a casing 90 defining in part an airflow path to receive airflow from the fan 38).

Further, it will be appreciated that the fan blade 40 (and each of the fan blades 40 of the fan 38) are formed of a composite material. It will be appreciated that as used herein, the phrase “formed of a composite material,” with reference to the fan blades 40, refers to at least 80% by weight of the fan blades 40, between the base 86 and the outer tip 84, being formed of one or more composite materials.

As alluded to earlier, the inventors discovered, unexpectedly during the course of designing gas turbine engines having a fan with composite fan blades—i.e., designing gas turbine engines having a fan (with composite fan blades) with various leading edge tip radii, leading edge hub radii, trailing edge tip radii, and trailing edge hub radii, and evaluating an overall engine and aeronautical efficiency performance—a significant relationship between the leading edge tip radii, leading edge hub radii, trailing edge tip radii, and trailing edge hub radii. The relationship can be thought of as an indicator of the ability of a gas turbine engine having a fan with composite fan blades to be able to provide a desired aeronautical efficiency for a given level of desired thrust output for the gas turbine engine. As will be appreciated, and as discussed above, the leading edge and trailing edge hub radii (for given leading edge and trailing edge tip radii) are driven by, and correlate to, a solidity and fan blade count of the fan, enabled by the formation of the fan blades out of composite materials, as lower leading edge and trailing edge hub radii (for given leading edge and trailing edge tip radii) require a fan with a lower solidity and a lower fan blade count.

The relationship applies to a gas turbine engine having a reduction gearbox to reduce a rotational speed of the fan relative to a driving turbine of a turbomachine of the gas turbine engine, a fan having fan blades formed of a composite material, and a high bypass ratio (i.e., a bypass ratio greater than or equal to 10). The relationship ties together a leading edge tip radius of a fan blade of the fan, a leading edge hub radius of the fan, a trailing edge tip radius of the fan blade of the fan, and a trailing edge hub radius of the fan, as described in more detail herein.

In particular, the inventors discovered that when designing a gas turbine engine, inclusion of a fan having fan blades with a large leading edge tip radius, the fan pressure ratio and rotational speed of the fan may be decreased, resulting generally in more efficiency. However, to avoid stall and generate a desired thrust output, a chord of the fan blades needs to be increased to ensure a sufficient airflow is provided through the fan. As the chord of the fan blade increases, the trailing edge tip radius of the fan blades may also increase to achieve a desired fan pressure ratio. Notably, however, the inventors found that increasing the leading edge tip radius too much resulted in increased weight and drag, offsetting the aerodynamic benefits otherwise achieved.

Further, with the chords of the fan blades increasing, the inventors of the present disclosure found that the solidity and fan blade count of the fan may be reduced, which may in turn result in lower leading edge and trailing edge hub radii (despite an increase in individual fan blade thickness as a result of forming the fan blades with composite materials). However, the inventors of the present disclosure found that the trailing edge hub radii could not be reduced too much without negatively affecting aerodynamics of an airflow into an inlet to the turbomachine, and the leading edge hub radii could not deviate too much from the trailing edge hub radii without negatively affecting a fan pressure ratio of the fan.

The relationship discovered, infra, can therefore identify a gas turbine engine having a fan having fan blades formed of a composite material, a reduction gearbox, and a high bypass ratio capable of achieving a desired aeronautical efficiency, while avoiding a prohibitive drag and weight increases, aerodynamic penalties, or combinations thereof and suited for particular mission requirements, one that takes into account efficiency, weight, structural needs for the fan blades, complexity, reliability, and other factors influencing the optimal choice for a gas turbine engine having a fan having fan blades formed of a composite material, a reduction gearbox, and a high bypass ratio.

In addition to yielding an improved gas turbine engine as noted above, utilizing this relationship, the inventors found that the number of suitable or feasible gas turbine engine designs capable of meeting the above design requirements could be greatly diminished, which facilitates a more rapid down selection of designs to consider as a gas turbine engine is being developed. Such a benefit provides more insight to the requirements for a given gas turbine engine well before specific technologies, integration and system requirements are developed fully. Such a benefit avoids late-stage redesign.

One such relationship providing for improved gas turbine engines, discovered by the inventors, is a Fan Leading Edge to Trailing Edge Compression Factor (FLTCF), expressed as:

$$FLTCF = \frac{{R}_{Fan \_ LE} ⨯ {R}_{Hub \_ TE}}{{R}_{Fan \_ TE} ⨯ {R}_{Hub \_ LE}} .$$

In the above expression of FLTCF, R_{Fan_LE} is a leading edge fan radius of a fan blade of a fan of a gas turbine engine, R_{Fan_TE} is a trailing edge fan radius of the fan blade of the fan of the gas turbine engine, R_{Hub_LE} is a leading edge hub radius of the fan of the gas turbine engine, and R_{Hub_TE} is a trailing edge hub radius of the fan of the gas turbine engine.

Another such relationship providing for the improved gas turbine engines, discovered by the inventors, is a Fan Leading Edge to Trailing Edge Opening Ratio (FLTOR), expressed as:

$$FLTOR = \frac{{R}_{Fan \_ LE} - {R}_{Hub \_ LE}}{{R}_{Fan \_ TE} - {R}_{Hub \_ TE}} .$$

In the above expression of FLTCF, R_{Fan_LE} is a leading edge fan radius of a fan blade of a fan of a gas turbine engine, R_{Fan_TE} is a trailing edge fan radius of the fan blade of the fan of the gas turbine engine, R_{Hub_LE} is a leading edge hub radius of the fan of the gas turbine engine, and R_{Hub_TE} is a trailing edge hub radius of the fan of the gas turbine engine.

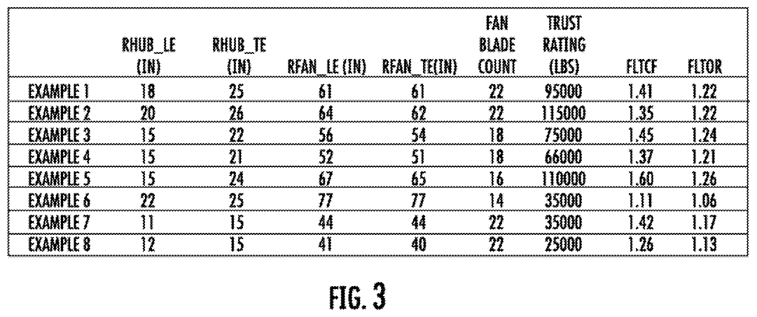

Example engines in accordance with one or more exemplary embodiments of the present disclosure are provided in the table of FIG. 3. The FLTCF is valid only when it is greater than or equal to 1.05 and less than or equal to 1.8. For example, in certain exemplary embodiments, the FLTCF is greater than or equal to 1.07 and less than or equal to 1.65. Further, the FLTOR is valid only when it is greater than or equal to 1.03 and less than or equal to 1.5. For example, in certain exemplary embodiments, the FLTOR is greater than or equal to 1.05 and less than or equal to 1.3. These and other aspects of FLTCF and FLTOR in which these relationships are valid are set forth below in Table 1. FLTCF and FLTOR are not valid outside of the ranges in Table 1.

TABLE 1

| Symbol | Description | FLTCP, FLTOR |
|---|---|---|
| R_{Fan}_LE | Leading edge fan radius of | 20 inches to 85 inches, such |
| | a fan blade of a fan of a gas | as 35 inches to 80 inches |
| | turbine engine | |
| R_{Fan}_TE | Trailing edge fan radius of the | 20 inches to 85 inches, such |
| | fan blade of the fan of the gas | as 35 inches to 68 inches |
| | turbine engine | |
| R_{Hub}_LE | Leading edge hub radius of the | 5 inches to 30 inches, such as |
| | fan of the gas turbine engine | 6 inches to 25 inches |
| R_{Hub}_TE | Trailing edge hub radius of the | 5 inches to 30 inches, such as |
| | fan of the gas turbine engine | 6 inches to 25 inches |
| FLTCF | Fan Leading Edge to Trailing | 1.05 to 1.8, such as 1.07 to |
| | Edge Compression Factor | 1.65 |
| FLTOR | Fan Leading Edge to Trailing | 1.03 to 1.5, such as 1.05 to |
| | Edge Opening Ratio | 1.3 |

Notably, each of exemplary engines noted in FIG. 3 defines a bypass ratio greater than or equal to 10 and less than or equal to 100, such as greater than or equal to 13, such as greater than or equal to 15, and less than or equal to 85, such as less than or equal to 70, such as less than or equal to 25. Further, each of the exemplary engines noted in FIG. 3 includes a reduction gearbox (and thus may be referred to as a geared gas turbine engine) defining a gear ratio greater than or equal to 2 and less than or equal to 14.

For example, in one exemplary embodiment, the gas turbine engine may be an unducted gas turbine engine (also referred to as an “open rotor engine”) including an unducted fan having fan blades formed of a composite material (see, e.g., the embodiment of FIG. 4, described below). In such an exemplary embodiment, a leading edge fan radius R_{Fan_LE} of a fan blade of the fan is greater than or equal to 65 inches and less than or equal to 85 inches, the fan defines a fan blade count greater than or equal to 5 and less than or equal to 15, a reduction gearbox defines a gear ratio greater than 4 and less than 12, and a thrust rating for the engine is between 20,000 pounds and 45,000 pounds. With such an exemplary embodiment the FLTCF is greater than or equal to 1.07 and less than or equal to 1.25, and the FLTOR is greater than or equal to 1.03 and less than or equal to 1.12. In such a manner, it will be appreciated that forming the fan blades of a composite material with this exemplary gas turbine engine enabled a size of the fan (both radially and in a chordwise direction) to be increased, allowing for a desired thrust output, despite a reduction in the fan blade count of the fan and solidity of the fan blades. Example 6 in FIG. 3 is an exemplary embodiment of such a gas turbine engine.

Further for example, in another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 35 inches and less than or equal to 50 inches, the fan defines a fan blade count greater than or equal to 12 and less than or equal to 23, a reduction gearbox defines a gear ratio greater than 2 and less than 4, and a thrust rating for the engine is between 20,000 pounds and 45,000 pounds. With such an exemplary embodiment the FLTCF is greater than or equal to 1.12 and less than or equal to 1.35, and the FLTOR is greater than or equal to 1.06 and less than or equal to 1.19. In such a manner, it will be appreciated that forming the fan blades of a composite material with this exemplary gas turbine engine enabled a size of the fan (e.g., in a chordwise direction) to be increased, allowing for a desired thrust output, despite a potential reduction in the fan blade count of the fan and solidity of the fan blades. Example 8 in FIG. 3 is an exemplary embodiment of such a gas turbine engine.

For example, in yet another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 51 inches and less than or equal to 66 inches, the fan defines a fan blade count greater than or equal to 17 and less than or equal to 23, a reduction gearbox defines a gear ratio greater than 1 and less than 4, and a thrust rating for the engine is between 60,000 pounds and 118,000 pounds. With such an exemplary embodiment the FLTCF is greater than or equal to 1.27 and less than or equal to 1.5, and the FLTOR is greater than or equal to 1.18 and less than or equal to 1.25. In such a manner, it will be appreciated that forming the fan blades of a composite material with this exemplary gas turbine engine enabled a size of the fan (e.g., in a radial direction and in a chordwise direction) to be increased, allowing for a desired thrust output, despite a potential reduction in the fan blade count of the fan and solidity of the fan blades. Examples 1 through 4 in FIG. 3 are exemplary embodiments of such a gas turbine engine.

Further for example, in still another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 55 inches and less than or equal to 70 inches, the fan defines a fan blade count greater than or equal to 12 and less than or equal to 22 (e.g., less than or equal to 19), a reduction gearbox defines a gear ratio greater than 1 and less than 4, and a thrust rating for the engine is between 100,000 pounds and 150,000 pounds (such as greater than 118,000 pounds and less than 150,000 pounds). With such an exemplary embodiment the FLTCF is greater than or equal to 1.46 and less than or equal to 1.65, and the FLTOR is greater than or equal to 1.2 and less than or equal to 1.5 (such as greater than or equal to 1.25 and less than 1.5). In such a manner, it will be appreciated that forming the fan blades of a composite material have enabled a size of the fan (e.g., in a radial direction and in a chordwise direction) to be increased, allowing for a desired thrust output, despite a potential reduction in the fan blade count of the fan and solidity of the fan blades. Example 5 in FIG. 3 is an exemplary embodiments of such a gas turbine engine.

Referring now to FIG. 4, a schematic cross-sectional view of a gas turbine engine 100 is provided according to another example embodiment of the present disclosure. The exemplary gas turbine engine 100 of FIG. 4 may be configured in substantially the same manner as the exemplary gas turbine engine 100 described above with reference to FIGS. 1 and 2.

For example, the exemplary gas turbine engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

Further, the exemplary gas turbine engine 100 generally includes a fan section 150 and a turbomachine 120. Generally, the turbomachine 120 includes, in serial flow order, a compressor section, a combustion section, a turbine section, and an exhaust section. Particularly, as shown in FIG. 4, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126; a high pressure (“HP”) compressor 128; a combustor 130; a high pressure turbine 132; and a low pressure turbine 134. The high pressure turbine 132 drives the high pressure compressor 128 through a high pressure shaft 136. The low pressure turbine 134 drives the low pressure compressor 126 and components of the fan section 150 through a low pressure shaft 138, and as such may be referred to as a drive turbine. After driving each of the turbines 132, 134, combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. By contrast to the embodiment of FIG. 1, for the depicted embodiment of FIG. 4, the fan 152 is an open rotor or unducted fan 152. In such a manner, the gas turbine engine 100 may be referred to as an open rotor engine.

As depicted, the fan 152 includes an array of fan blades 154 (only one shown in FIG. 4). The fan blades 154 are rotatable, e.g., about the longitudinal axis 112. As noted above, the fan 152 is drivingly coupled with the low pressure turbine 134 via the LP shaft 138. As with the exemplary embodiments discussed above, the fan blades 154 are formed of a composite material.

Further for the embodiments shown in FIG. 4, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. Each fan blade 154 defines a central blade axis 156. For this embodiment, each fan blade 154 of the fan 152 is rotatable about its central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 4) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 4 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to the fan cowl 170.

By contrast to the embodiment of FIG. 1, as shown in FIG. 4, in addition to the unducted fan 152, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the low pressure turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 4) arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 4). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The engine 100 also defines or includes an inlet duct 180. The inlet duct 180 extends between the engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. In the embodiment depicted, the inlet duct 180 is wider than the core duct 142 along the radial direction R. The inlet duct 180 is also wider than the fan duct 172 along the radial direction R.

Moreover, referring still to FIG. 4, in exemplary embodiments, air passing through the fan duct 172 may be relatively cooler (e.g., lower temperature) than one or more fluids utilized in the turbomachine 120. In this way, one or more heat exchangers 186 may be positioned in thermal communication with the fan duct 172. For example, one or more heat exchangers 186 may be disposed within the fan duct 172 and utilized to cool one or more fluids from the core engine with the air passing through the fan duct 172, as a resource for removing heat from a fluid, e.g., compressor bleed air, oil or fuel.

Although not depicted in the example of FIG. 4, the heat exchanger 186 may be an annular heat exchanger extending substantially 360 degrees in the fan duct 172 (e.g., at least 300 degrees, such as at least 330 degrees). In such a manner, the heat exchanger 186 may effectively utilize the air passing through the fan duct 172 to cool one or more systems of the engine 100 (e.g., lubrication oil systems, compressor bleed air, electrical components, etc.). The heat exchanger 186 uses the air passing through duct 172 as a heat sink and correspondingly increases the temperature of the air downstream of the heat exchanger 186 and exiting the fan exhaust nozzle 178.

As will be appreciated from the description herein, various other embodiments of a gas turbine engine are provided. Certain of these embodiments may be an unducted, single rotor gas turbine engine, or a ducted gas turbine engine. Various additional aspects of one or more of these embodiments are discussed below. These exemplary aspects may be combined with one or more of the exemplary gas turbine engine(s) discussed above with respect to the figures.

In one or more of these embodiments, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 pounds per square inch absolute (psia) and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps.

A fan pressure ratio (FPR) for the fan of the fan assembly can be 1.04 to 1.20, or in some embodiments 1.05 to 1.1, or in some embodiments less than 1.08, as measured across the fan blades at a cruise flight condition.

In order for the gas turbine engine to operate with a fan having the above characteristics and provide the benefits noted herein associated with forming the fan blades from a composite material, a gear assembly may be provided to reduce a rotational speed of the fan assembly relative to a driving shaft (such as a low pressure shaft coupled to a low pressure turbine). In some embodiments, a gear ratio of the input rotational speed to the output rotational speed is greater than or equal to 2. For example, in particular embodiments, the gear ratio is within a range of 4.1 to 14.0, within a range of 4.5 to 14.0, or within a range of 6.0 to 14.0. In certain embodiments, the gear ratio is within a range of 4.5 to 12 or within a range of 6.0 to 11.0. As such, in some embodiments, the fan can be configured to rotate at a rotational speed of 700 to 1500 revolutions per minute (rpm) at a cruise flight condition, while the power turbine (e.g., the low-pressure turbine) is configured to rotate at a rotational speed of 2,500 to 15,000 rpm at a cruise flight condition. In particular embodiments, the fan can be configured to rotate at a rotational speed of 850 to 1,350 rpm at a cruise flight condition, while the power turbine is configured to rotate at a rotational speed of 5,000 to 10,000 rpm at a cruise flight condition.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low pressure compressor may include 1 to 8 stages, a high-pressure compressor may include 8 to 15 stages, a high-pressure turbine may include 1 to 2 stages, and/or a low pressure turbine (LPT) may include 3 to 7 stages. In particular, the LPT may have 4 stages, or between 4 and 7 stages. For example, in certain embodiments, an engine may include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

In further embodiments of the gas turbine engine and fan systems described herein, the composite fan blade architectures and fan system relationships disclosed in the present application may be combined with fan aerodynamic configurations exhibiting reduced blade solidity and tailored spanwise solidity distributions, as described in related embodiments. In particular, the fan blades formed of composite materials may be configured to operate with a reduced number of fan blades and corresponding solidity values, while maintaining structural integrity, aerodynamic loading capability, and operability across the engine operating envelope.

More specifically, in certain embodiments, the composite fan blades described herein may be incorporated into fan assemblies having a number of fan blades between thirteen and twenty-one, as well as intermediate ranges thereof, with blade solidity values that vary as a function of radial position along the blade span. For example, blade solidity may be relatively low at one or more inboard span locations while remaining near unity at or proximate to the blade tips. Such spanwise solidity profiles, including those defined at approximately 30%, 60%, and 90% of blade span, may be selected in coordination with relative Mach number distributions to reduce aerodynamic losses, improve cruise efficiency, and/or maintain adequate stall margin. When implemented using composite fan blades as disclosed herein, these aerodynamic relationships permit fan designs that would otherwise be impractical using metallic blade constructions due to thickness, weight, or hub radius constraints.

In particular, because blades with lower solidity values may require a fan blade with a large chord value, such lower solidity fan blades experience higher loading per blade. Using a metallic fan blade for a lower solidity fan blade may result in structural or durability limitations, because metallic fan blades may not provide the required strength-to-weight ratio achievable by a composite fan blade. Fan blades with lower solidity values result in a more efficient gas turbine engine. Fan blades with composite fan blades result in durable fan blades able to withstand higher loading per blade. Therefore, combining a design of fan blades with lower solidity values with a design of composite fan blades having an FLTCF between 1.05 and 1.8, as described herein, results in fan blades that are both efficient and durable.

As a result, the combination of composite fan blade construction with low-solidity and part-span-solidity fan configurations yields synergistic performance benefits. In particular, the ability of composite fan blades to support increased chord length, tailored thickness distributions, and reduced blade count enables fan designs in which solidity-to-Mach-number ratios at multiple spanwise locations can be selectively controlled, resulting in improved aerodynamic efficiency without the conventional penalties associated with reduced solidity. These effects are not merely additive, but arise from the interaction between composite structural capability and aerodynamic design freedom, and therefore represent improvements of the fan system concepts described above.

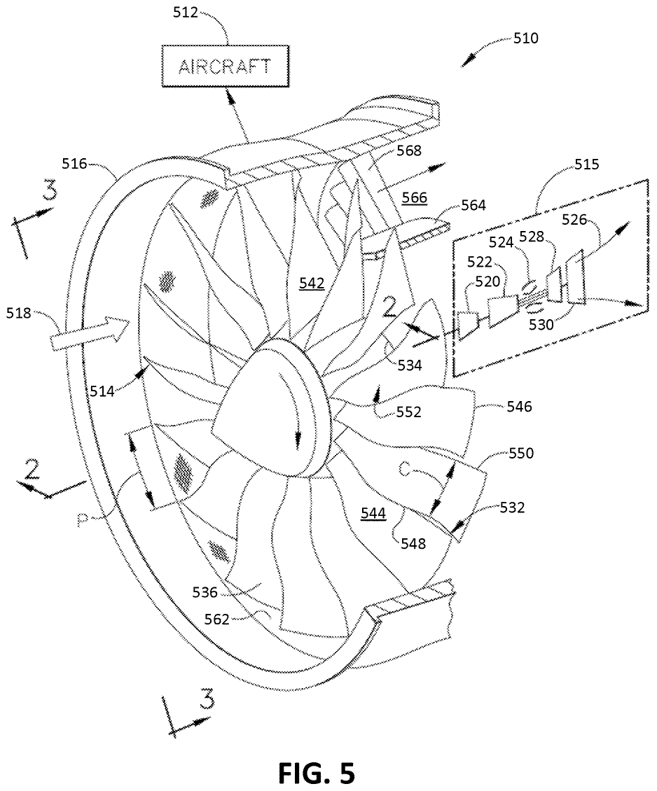

Illustrated in FIG. 5 is a gas turbine engine 510 configured for powering an aircraft 512 in flight, and suitably mounted therein. The engine is axisymmetrical about a longitudinal or axial centerline axis and includes a fan or turbofan 514 suitably mounted coaxially inside a surrounding annular fan casing 516.

During operation, ambient air 518 enters the inlet end of the fan 514 and is pressurized thereby for producing propulsion thrust for propelling the aircraft in flight. The fan 514 is driven by a prime mover 515 which is illustrated schematically by a dashed line in FIG. 5. The prime mover may be any device operable to rotate the fan 514 at the required speed under expected mechanical and aerodynamic loads. Nonlimiting examples of prime movers include heat engines, motors (e.g. electric, hydraulic, or pneumatic), or combinations thereof (for example electric hybrid). The fan 514 may be driven directly by the prime mover 515, or through an intermediate geartrain. In the illustrated example, the prime mover 515 comprises a gas turbine engine. A portion of the fan air is suitably channeled in turn through a low pressure or booster compressor 520 and a high pressure compressor 522 which further pressurize the air in turn.

The pressurized air is mixed with fuel in an annular combustor 524 for generating hot combustion gases 526 which are discharged in the downstream direction. A high pressure turbine (HPT) 528 first receives the hot gases from the combustor for extracting energy therefrom, and is followed in turn by a low pressure turbine (LPT) 530 which extracts additional energy from the combustion gases discharged from the HPT. The HPT is joined by one shaft or rotor to the high pressure compressor 522, and the LPT is joined by another shaft or rotor to both the booster compressor 520 and the fan 514 for powering thereof during operation.

The exemplary turbofan engine 510 illustrated in FIG. 5 may have any conventional configuration and operation for powering an aircraft in flight from takeoff to cruise to landing, but is modified as further described hereinbelow for increasing the aerodynamic efficiency of the fan 514 while maintaining suitable stability and stall margin thereof during the operating cycle.

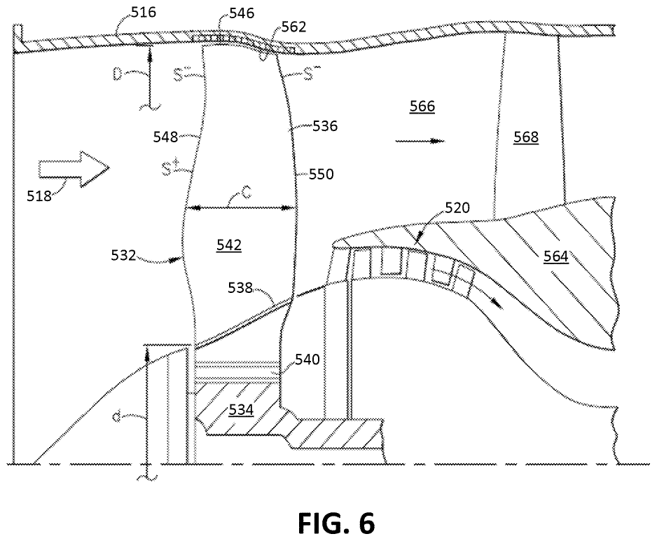

More specifically, FIGS. 5 and 6 illustrate an exemplary embodiment of the turbofan 514 which includes a row of fan rotor blades 532 extending radially outwardly in span from the perimeter rim of a supporting rotor disk 534. As shown in FIG. 6, each blade includes an airfoil 536 extending outwardly from a platform 538 defining the radially inner boundary of the fan air flowpath, which platform may be integrally formed with the airfoil or a separate component. The principles of the present disclosure apply equally to a fan having a disk with separate blades as well to a fan having the blades integrally formed with the disk, also referred to as a “bladed disk,” “integrally-bladed rotor,” or “blisk.” In the illustrated example, each blade also includes an integral dovetail 540 extending radially inwardly from the airfoil below the platform for mounting each blade in a corresponding dovetail slot in the rim of the rotor disk 534.

The fan blades 532 may be made from suitable high strength materials like titanium or carbon fiber composites. For example, the majority of the fan blade 532 may be formed of carbon fiber composite reinforced with titanium shields along the leading and trailing edges, and along the tip.

As illustrated in FIGS. 5 and 6, each airfoil 536 has a suitable aerodynamic configuration including a generally concave pressure side 542 and a circumferentially opposite, generally convex suction side 544. The opposite sides of each airfoil extend radially in span from the inner root end thereof at the platform 538 to the radially outer distal tip 546 disposed closely adjacent to the fan stator casing 516 for providing a relatively small tip clearance or gap therebetween.

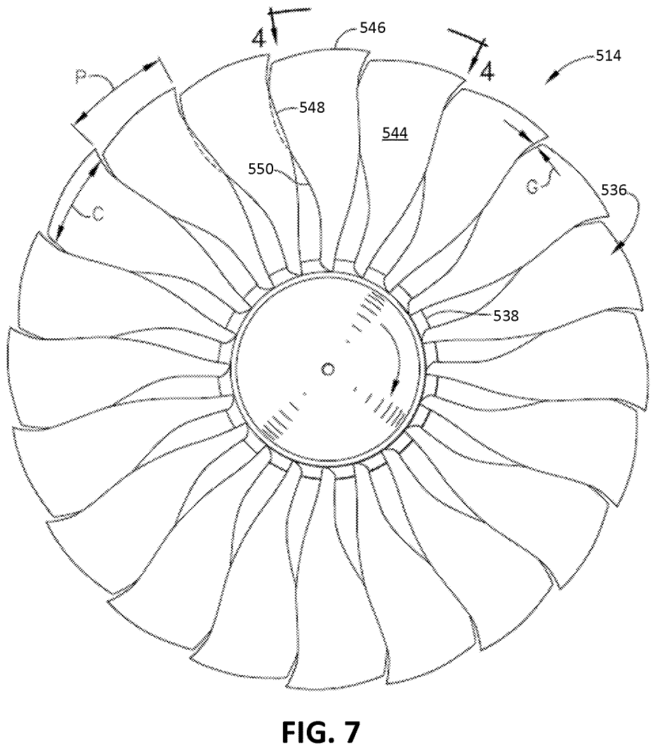

As shown in FIGS. 6 and 7, each airfoil extends axially in chord C between opposite leading and trailing edges 548 and 550, with the chord varying in length over the span of the airfoil.

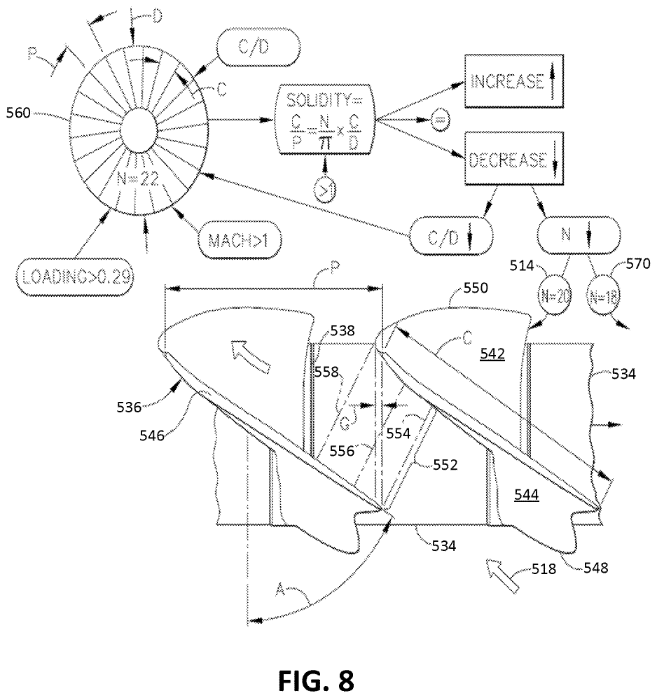

As shown in FIG. 8, adjacent airfoils 536 define circumferentially therebetween corresponding flow passages 552 for pressurizing the air 518 during operation. Each of the airfoils 536 may include stagger or twist represented by the stagger angle A from the axial or longitudinal axis, which stagger increases between the root and tip of the airfoil.

For example, the stagger angle A at the blade tip may be substantial, and about 60 degrees, to position the leading edge 548 of one airfoil circumferentially adjacent but axially spaced from the suction side 544 of the next adjacent airfoil aft from the leading edge thereof to define a corresponding mouth 554 for the flow passage between the opposing pressure and suction sides of the adjacent airfoils. The contours and stagger of the adjacent airfoils over the radial span of the blades cause each flow passage to converge or decrease in flow area to a throat 556 of minimum flow area spaced aft from the mouth along most, if not all, of the radial span.

As further illustrated in FIG. 8, the relatively high airfoil stagger A also positions the trailing edge 550 of one airfoil 536 circumferentially adjacent to the pressure side 542 of the next adjacent airfoil while also being spaced axially therefrom in the tip region to define a corresponding discharge or outlet 558 for the corresponding flow passage between adjacent airfoils. In this way, the incoming air 518 is channeled in the corresponding flow passages 552 between adjacent airfoils as they rotate clockwise in FIGS. 5,7, and 8 for pressurizing the air to produce the propulsive thrust during operation.

FIGS. 5-8 illustrate in general the typical configuration of a modern turbofan aircraft engine having a row of fan blades with corresponding stagger or twist from root to tip. There are many competing design parameters for the turbofan for balancing fan efficiency with stability and stall margin and with aero-mechanical parameters affecting flutter and noise and with mechanical strength of the fan blade subject both to centrifugal force during operation and aerodynamic loading. FIGS. 5 and 6 further illustrate that the turbofan aircraft engine includes an annular tip shroud 562 suitably mounted flush inside the fan stator casing 516 and directly surrounding the airfoil tips 546, which are positioned closely adjacent thereto to define a correspondingly small tip clearance therewith. The tip shroud 562 may include a lightweight honeycomb structure, with a substantially smooth inner surface facing the blade tips. The low solidity turbofan results in improved efficiency while maintaining adequate stability and stall margin without the need for stability enhancing features such as annular grooves which could otherwise be formed in the tip shroud.

As shown in FIG. 6, the fan casing 516 is spaced radially outwardly from an inner casing 564, which surrounds the core engine to define an annular bypass duct 566 radially therebetween. The aft end of the bypass duct 566 defines the outlet for a majority of the fan air used in producing propulsive thrust for the engine. Spaced downstream or aft from the row of fan blades 532 is a row of outlet guide vanes 568 extending radially inwardly from the fan casing 516 to join the inner casing 564.

FIG. 8 illustrates schematically a method of improving aerodynamic efficiency of the turbofan engine 510 illustrated in FIG. 5 by derivation for example. Modern turbofan engines are typically derived from existing engines having proven experience in commercial service. Corresponding changes or modifications thereof may then be effected in accordance with conventional design practices, which, however, must be balanced in view of the various competing parameters such as efficiency and stall margin, for example. Further increasing efficiency and aerodynamic loading typically requires reduction in stall margin, and must therefore be balanced for overall performance.

FIG. 8 illustrates schematically a previous design of a fan 560 for use in the type of turbofan engine illustrated in FIG. 5. This pre-existing fan has a full complement of only twenty-two fan blades of suitably large outer diameter D for effecting supersonic airflow at the tips during operation.

The pre-existing fan 560 also has a corresponding solidity which is a conventional parameter equal to the ratio of the airfoil chord C, as represented by its length, divided by the circumferential pitch P or spacing from blade to blade at the corresponding span position or radius. The fan 514 also has a corresponding solidity equal to the ratio of the airfoil chord C, as represented by its length, divided by the circumferential pitch P or spacing from blade to blade at the corresponding span position or radius.

In some embodiments, the solidity is defined based on an airfoil chord C in the blade tip region of the blade. As used herein, a blade span is defined as a radial distance extending from a blade root to a blade tip. A spanwise location, also referred to herein as a “tip radius,” is expressed as a percentage of the blade span measured from the blade root toward the blade tip, such that the blade root is located at 0% span (or 0% tip radius) and the blade tip is located at 100% span (or 100% tip radius). The blade tip region is defined as a portion of the blade span extending from a spanwise location of 90% to a spanwise location of 100%.

The circumferential pitch is equal to the circumferential length at the specific radial span divided by the total number of fan blades in the blade row. Accordingly, the solidity is directly proportional to the number of blades and chord length and inversely proportional to the diameter as shown schematically in FIG. 8.

As indicated above, modern design practice requires the solidity of the blades at the airfoil tips to be generally similar in magnitude to the relative Mach number of the flow stream at the airfoil tips. In this exemplary embodiment, the tip solidity of the pre-existing fan 560 is relatively high at about 1.29 and corresponds well with a similar tip relative Mach number of also about 1.29.

Conventional practice as indicated above requires relatively high tip solidity for maintaining good efficiency in a supersonic blade tip design subject to shock in the flow passages between the adjacent airfoils, and therefore increasing solidity is one option, of the various design parameters for a modern turbofan, in producing a derivative fan. Or, tip solidity may remain the same, or equal, in the derivative fan.

However, it has been discovered that notwithstanding this conventional practice for relatively high solidity in modern turbofans, a substantial improvement in efficiency while maintaining adequate stability and stall margin may be obtained by decreasing tip solidity, and not increasing tip solidity. As indicated above, solidity is proportional to the number of fan blades and the ratio of the airfoil chord divided by the diameter of the fan.

Accordingly, solidity may be decreased by decreasing the number of fan blades, decreasing the airfoil chord, or increasing the outer diameter of the fan. However, the fan outer diameter is typically a given parameter for a specifically sized turbofan engine. And, it has been further discovered that reducing solidity by reducing the length of the chord is detrimental to turbofan efficiency, whereas reducing the blade count to reduce solidity can improve turbofan efficiency.

FIG. 8 illustrates schematically these various options in turbofan design based on the blade solidity. Decreasing solidity by reducing the chord to diameter C/D ratio maintains constant the number of fan blades, for example twenty-two, yet analysis indicates a reduction in efficiency.

Correspondingly, the chord to diameter C/D ratio may remain constant or equal between the turbofan designs, with instead the number of fan blades being reduced to twenty or eighteen in the preferred embodiments.

It is further noted that fan blades for a particular fan would tend to have approximately the same thickness dimension even if the chord dimension is varied, because the thickness dimension is usually set for structural reasons as opposed to aerodynamic reasons. Accordingly, a parameter referred to as “thickness blockage” tends to be less when the blade count is lower. For this reason, considering a given solidity, there is an efficiency advantage to achieving this solidity in part through a lower blade count.

Accordingly, aerodynamic efficiency may be improved in the turbofan engine 10 by using a relatively smaller number of fan blades 32 compared to previous designs. For example, as illustrated in FIG. 5 by deriving the fan 514 from the pre-existing fan 560 and reducing the solidity at the airfoil tips by reducing the number of blades from twenty-two to either twenty or eighteen, for example, while maintaining substantially equal or constant the same ratio of the tip chord over the tip diameter C/D in the derived fan 514 as originally found in the pre-existing fan. In some embodiments, the fan 514 may include thirteen to twenty-one fan blades 532. In other embodiments, the fan 514 may include fifteen to twenty fan blades 532.

Furthermore, the reduction in number of fan blades increases the circumferential pitch P between the airfoils and increases the flow area of the flow passages 552, in particular at the throats 556 thereof, for reducing flow blockage during operation, and specifically at the airfoil tips subject to supersonic operation.

Accordingly, the derived turbofan 514 illustrated in FIGS. 5-8 includes no more than twenty of the fan blades 532 effected by reducing the tip solidity which has a relatively low magnitude at the tips 546 to position the leading edge 548 of each tip 546 circumferentially near the trailing edge 550 of the next adjacent tip 546, and correspondingly increase the width of the throat 554 normal or perpendicular between the opposing pressure and suction sides of adjacent airfoils.

The reduction in fan blade number while maintaining substantially constant the chord to diameter C/D ratio at the airfoil tips has significant advantages in the new turbofan including an increase in efficiency while maintaining adequate stability and stall margin, as well as reducing noise, as well as reducing weight and cost due to the fewer fan blades.

Quite significant in the low solidity turbofan design is the substantial reduction in flow blockage at the passage throats which more than offsets the decreased solidity effect on aerodynamic performance. Modern computational flow dynamics analysis predicts that lower solidity through reduced blade number is beneficial to cruise efficiency whereas lower solidity through reduction of the chord to diameter C/D ratio would be detrimental to cruise efficiency, which has been confirmed by testing.

FIG. 7 is a front view of the turbofan 514, with FIG. 8 being a top planiform view which illustrate the substantial change in appearance of the turbofan as opposed to typical high solidity turbofans in which the adjacent fan blades substantially overlap each other circumferentially due to the high solidity and high stagger of the airfoils.

In contrast, the tip solidity of the turbofan illustrated in FIGS. 7 and 8 is relatively low in magnitude, while still being greater than about 1.0 to provide a circumferential gap G between the leading and trailing edges 548 and 550 of adjacent tips 546.

In particular, since the low solidity is effected by reducing the blade count instead of reducing the chord to diameter C/D ratio, this ratio, and chord, remain relatively large in value, which along with the increased circumferential pitch P and large stagger A of the airfoils is effective to provide the circumferential gap G locally between the leading and trailing edges of the adjacent tips.

The configuration of the flow passage 552 illustrated in FIG. 8 is particularly important to efficient operation of the fan, and in particular at the airfoil tips subject to supersonic flow. The specific profiles of the pressure and suction sides of the individual airfoils, the lateral thickness of the airfoil, the root to tip stagger A of the airfoils and, of course, the reduced solidity due to the reduction in blade count while maintaining equal the chord to diameter C/D ratio are all used to define each flow passage 552.

In particular, the airfoil tips 536 are locally angled and vary in width between the leading and trailing edges 548 and 550 to typically converge the flow passage 552 at the airfoil tips from the mouth 554 to the throat 556 and then diverge the flow passage also at the tip from the throat 556 to the outlet 558. Alternatively, the mouth and throat of the flow passages at the airfoil tips may be coincident in one plane at the leading edges, with the flow passages still diverging aft from the throats at the leading edges to the passage outlets at the trailing edges.

The convergence angle or slope between the mouth and the throat, and the divergence angle or slope between the throat and the outlet may be specifically designed for maximizing efficiency during supersonic operation of the blade tips in which aerodynamic shock is generated as the airflow is reduced in speed in the converging portion to choked flow of Mach 1 at the throat 556 followed in turn by subsonic diffusion in the diverging portion of the flow passage from or aft of the throat to the outlet.

The ratio of the flow area at the passage outlet 558 over the flow area at the throat 556 is a conventional measure of effective camber of the airfoils. The actual amount of airfoil camber at the tips thereof may be increased slightly over a conventional turbofan design to allow the turbofan to tolerate the lower tip solidity during part-speed operation.

As indicated above, a modern turbofan is designed for an operating range from takeoff to cruise to landing, with cruise operation being predominant and for which maximum efficiency and operability is desired. However, part-speed performance must also be considered in good turbofan design and accommodated by the higher camber introduced at the blade tips for the low solidity turbofan design.

Accordingly, part-speed operability may be improved by increasing the camber of the airfoils 536 at the tips 546 thereof in conjunction with the reduction in solidity by reduction in blade count.

Since improved efficiency of the fan may be obtained through lowering solidity, the turbofan design may itself be otherwise conventional except as modified in accordance with the present disclosure. For example, the airfoils 536 illustrated in FIGS. 5-8 are relatively large in diameter for supersonic tip operation in a modern turbofan engine with a substantial pressure ratio of about 1.5. The corresponding bypass ratio of the fan air which bypasses the core engine is about 7.5 or greater. And, the airfoils may be provided with suitable aerodynamic sweep which is preferably forward or negative (S−) at the tips 546 of the airfoils, and preferably negative along both the leading and trailing edges 548 and 550 thereof.

The individual airfoils may have a large chord barreling near their midspan as illustrated in FIG. 6 with aft or positive aerodynamic sweep (S+) along a portion of the leading edge above the midspan if desired. This form of modern turbofan blade is disclosed in substantial detail in U.S. Pat. No. 6,328,533, and is incorporated herein by reference.

Aerodynamic sweep is also a conventional term of art and is disclosed in detail in U.S. Pat. No. 5,167,489, also incorporated herein by reference. The forward tip sweep in the fan blades improves efficiency during supersonic operation of the blade tips.

FIGS. 5 and 6 also illustrate that the turbofan includes an annular tip shroud 562 suitably mounted flush inside the fan stator casing 516 and directly surrounding the airfoil tips 546 which are positioned closely adjacent thereto to define a correspondingly small tip clearance therewith. The tip shroud 562 may be conventional in configuration, such as a lightweight honeycomb structure, with a substantially smooth inner surface facing the blade tips. The low solidity turbofan enjoys improved efficiency while maintaining adequate stability and stall margin without the need for stability enhancing features such as annular grooves which could otherwise be formed in the tip shroud.

As shown in FIG. 6, the fan casing 516 is spaced radially outwardly from an inner casing 564 which surrounds the core engine to define an annular bypass duct 566 radially therebetween. The aft end of the bypass duct 566 defines the outlet for a majority of the fan air used in producing propulsion thrust for the engine.

Spaced downstream or aft from the row of fan blades 532 is a row of outlet guide vanes 568 extending radially inwardly from the fan casing 516 to join the inner casing 564. The number of vanes 568 is preferably more than twice the number of the fan blades 532 for reducing noise from the fan during operation.

Noise reduction, and in particular spinning mode noise, is disclosed in U.S. Pat. No. 5,169,288, incorporated herein by reference, which patent may be used for determining the specific number of vanes 568 relative to the specific number of fan blades, and for example may number 548 vanes for both the twenty and eighteen fan blade species.

FIG. 6 illustrates another feature which may be introduced into the turbofan. In particular, the airfoil tips 546 may have an axially arcuate contour radially outwardly between the leading and trailing edges, and the adjacent tip shroud 562 may have a complementary axially arcuate contour radially inwardly for maintaining a substantially uniform tip clearance radially therebetween, and axially between the leading and trailing edges 548 and 550 of the airfoils. In one embodiment, the forward portion of the airfoil tip 546 is convex followed in turn by a concave aft portion. Correspondingly, the tip shroud 546 has a forward concave portion followed by a convex aft portion for reducing tip losses and flow blockage during supersonic operation of the fan blades in particular.

U.S. Pat. No. 6,338,609 discloses particular details of this special tip arrangement and is incorporated herein by reference.

Furthermore, the blade platforms 538 illustrated in FIG. 6 may be fluted for further improving aerodynamic performance of the turbofan. Fluted platforms or radially inner endwalls are disclosed in more detail in U.S. Pat. No. 6,561,761, also incorporated herein by reference.

The incorporation by reference of these various patents listed above are merely exemplary of the various modern features which may be incorporated in the turbofan 14 for fully maximizing efficiency thereof. These and other conventional features may be used in the turbofan for conventional advantage, in addition to the improved modification of the turbofan by reducing tip solidity through blade count instead of reducing chord to diameter C/D ratio.

The twenty-two fan blades in the pre-existing turbofan 560 illustrated in FIG. 8 is already a relatively low number of fan blades in a modern turbofan engine. However, reducing tip solidity by reducing blade count instead of the chord to diameter C/D ratio permits a further improvement of turbofan efficiency as disclosed above, and in two embodiments analyzed using modern computational flow dynamics analysis and tested, only twenty or only eighteen of the fan blades 532 may be used in the improved turbofan design, with the chord to diameter C/D ratio at the airfoil tips 546 being the same or equal in both species or designs. Although the individual fan blades may be scaled in size with the constant chord to diameter C/D ratio, the collective assembly of fan blades in the resulting turbofan cannot be scaled in view of the desirable reduction in tip solidity by the corresponding reduction in blade count.

FIGS. 5-8 illustrate one embodiment or species in which tip solidity is reduced through blade count reduction from twenty-two to twenty, with a corresponding tip solidity no greater than about 1.2.

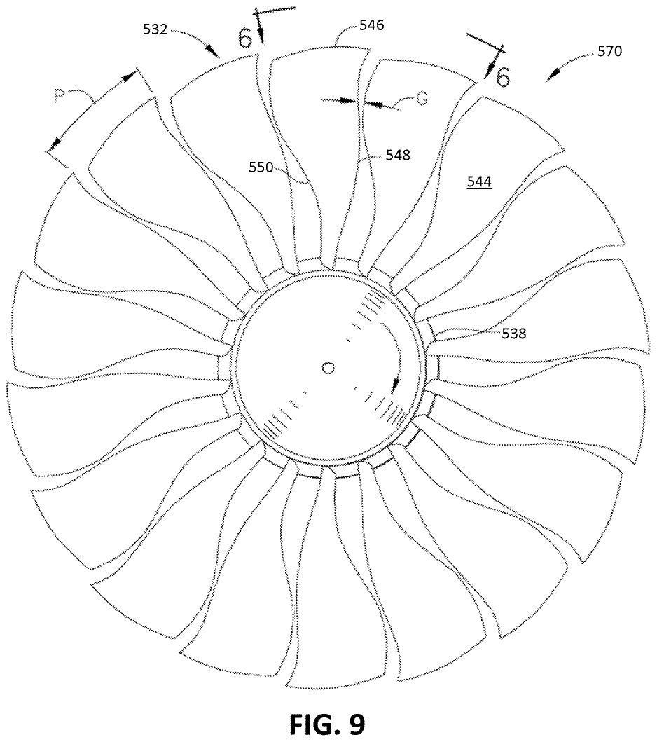

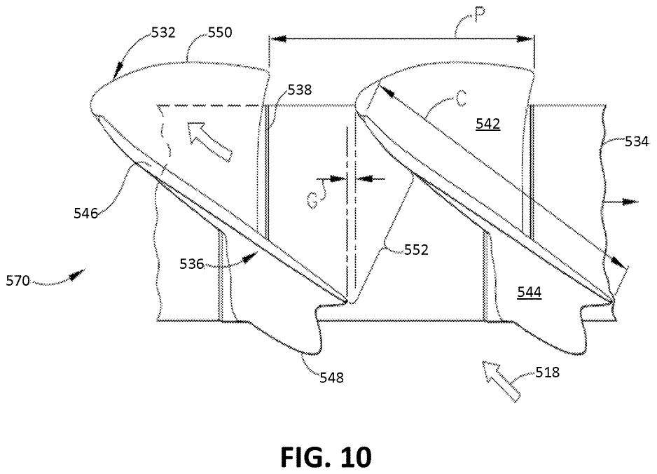

FIGS. 9 and 10 illustrate a second embodiment or species of the turbofan, designated 570, having low solidity due to a further reduction in blade count to only eighteen fan blades 532 with the same chord to diameter C/D ratio at the airfoil tips as that found in the first embodiment, with both embodiments having a solidity greater than about 1.0.

In both embodiments of the turbofans, the blades thereof are sized and configured in accordance with modern practice for pressurizing the air 518 under a relatively large aerodynamic loading. Aerodynamic loading is a conventional parameter defined by the ratio of the specific enthalpy rise axially across the airfoils 536 over the square of velocity of the airfoil tips 546 at a corresponding design point, like cruise operation.

A modern turbofan has the highest aerodynamic loading found in fans of any type, and are well contrasted with non-aircraft engine fans typically found in automobiles and appliances and other commercial applications. For example, the aerodynamic loading of the turbofans illustrated in the several FIGS. may have a value of at least about 0.29, and cooperates with the relatively high pressure ratio of the fans greater than about 1.5, and the high bypass ratio of the turbofan engine for producing substantial propulsion thrust during operation.

In the typical turbofan aircraft engine application, the fan blades have relatively large diameter and are rotated for achieving supersonic tip velocities thereof. Accordingly, the converging-diverging flow passages 552 illustrated in FIG. 8, for example, are specifically sized and configured for receiving supersonic flow of the incident ambient air 518 at the leading edges 548, which will be followed in turn by shock in the passages, and subsonic diffusion aft of the throats 556.

As indicated above, the slope angles of the opposing pressure and suction sides of the adjacent airfoils may be selected for creating a specifically converging portion of each flow passage between the mouth 554 and the throat 556, and a specifically diverging portion between the throat 556 and outlet 558 for maximizing efficiency of flow diffusion in the subsonic flow following the choked flow at the flow passage throat.

In the first embodiment illustrated in FIGS. 7 and 8, the blade row includes only twenty fan blades 532, and the tip solidity is about 1.17.

The adjacent airfoils 536 in this embodiment have a circumferential gap G near or at the tips 546, followed radially inwardly by slight circumferential overlap between the airfoils, with the trailing edge 550 of the leading airfoil being hidden behind the leading edge 548 of the following airfoil when viewed from the front.

Radially inwardly below the airfoil overlap, the circumferential gap reappears and increases towards and near the airfoil roots. For example, adjacent airfoils may have the tip gap over the top ten percent of the radial span, circumferential overlap over the next 40 percent of the span, with additional circumferential gap over the bottom 50 percent of the span.

In the second embodiment illustrated in FIGS. 9 and 10, the blade row includes only eighteen fan blades 532 with an even lower tip solidity of about 1.05 due to the reduction in blade count, with the chord to diameter C/D ratio at the blade tips being substantially the same as that in both the first embodiment disclosed above as well as in the pre-existing fan 560 illustrated schematically in FIG. 8.

In this embodiment, the circumferential gap G between adjacent airfoils 536 extends the full radial span from root to tip 546 of the airfoils, without any circumferential overlap therebetween as viewed from the front. The magnitude of the circumferential gap G is substantially smaller than the magnitude of the circumferential pitch P of the blades, which eighteen blades complete the full row thereof with a correspondingly larger pitch attributed to the reduction in blade count.

Nevertheless, the inter-blade flow passages 552 are formed between the adjacent airfoils and enjoy the advantage of the reduced throat blockage thereof, and enhanced performance at supersonic airflow at the blade tips. Like FIG. 8, the FIG. 10 embodiment has a suitably configured converging-diverging flow passage 552 between the adjacent airfoils for providing choked flow at the throat between the mouth and outlet, and subsonic diffusion aft of the throat.

Computational flow dynamic analysis predicts an additional increase in aerodynamic efficiency of the eighteen count turbofan illustrated in FIGS. 9 an 10 over the twenty count turbofan illustrated in FIGS. 7 and 8, while still maintaining an adequate stability and fan stall margin over the operating range. And, both embodiments have improved efficiency over the pre-existing, twenty-two count fan 560 illustrated in FIG. 8 designed in accordance with conventional high solidity teachings.

The low solidity by reduced blade count turbofan disclosed above may be used in various designs of modern turbofan aircraft gas turbine engines for improving efficiency thereof. Particularly advantage is obtained for relatively large diameter transonic turbofans in which the blade tips are operated with supersonic airflow.

Accordingly, the engine illustrated in FIG. 5 is used for powering the fan 514 for producing propulsion thrust for powering the aircraft 512 in flight. The airfoil tips 546 are rotated for achieving supersonic flow of the air 518 at the leading edges 548 thereof. The airfoils 536 are aerodynamically loaded to propel the aircraft at cruise with increased efficiency due to the low solidity by blade count reduction, while maintaining stability and stall margin of the fan.

The twenty and eighteen blade count turbofans disclosed above have been analyzed with modern computational flow dynamic analysis, and have been tested in scale model to confirm the increase in aerodynamic efficiency thereof while maintaining adequate stability and stall margin. The analysis and test also confirm reduction in acoustic signature or noise. The reduced blade count correspondingly reduces engine weight and cost.

Low solidity through blade count reduction fewer than eighteen blades has also been investigated, but not tested, in a turbofan having sixteen blade count and the high aerodynamic loading. In this configuration, no significant increase or decrease in efficiency was observed. However, this configuration offers the advantage of reduced weight, which is significant for overall aircraft performance. Nevertheless, such reduced-count designs may be further investigated for confirming whether or not they are practical or viable in a modern turbofan engine.

It has been found that reduction of solidity at locations inboard of the tip 546 is useful to improve aerodynamic performance and/or aerodynamic efficiency of the fan 514. This reduction of solidity may be implemented by reducing chord Cat locations inboard of the tip 546.

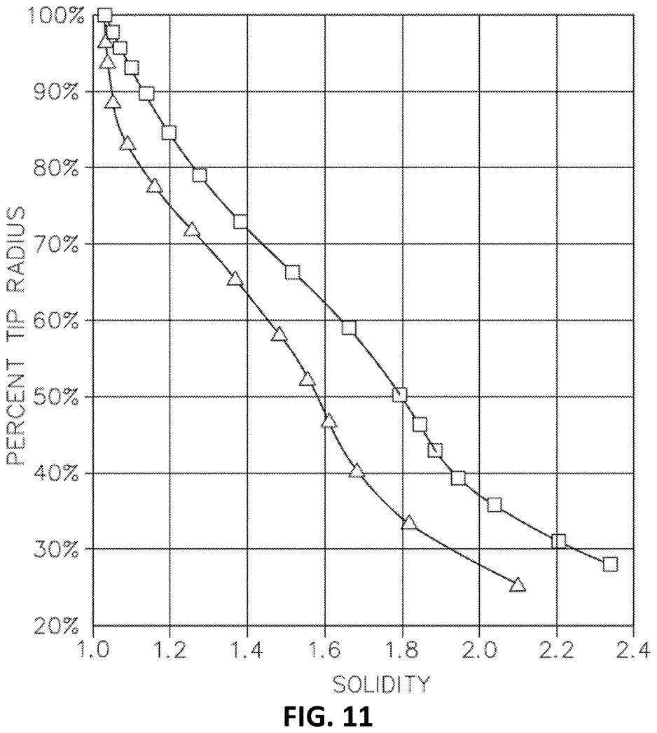

FIG. 11 illustrates the characteristics of the fan design according to an aspect of the present invention (shown by a line with triangular markers) as compared to a prior art design (shown by a line with square markers). It can be seen that, while the solidity is close to 1.0 at the tip for both designs, the solidity of the fan 514 is lower at all locations inboard of the tip. The offset graph describing the lowered solidity at inboard locations may be characterized by the solidity values at representative locations along the span.

One representative location is at 90% of the radial distance from the axial centerline to the tip, also referred to herein as “90% of tip radius”. For example, the fan 514 may have a solidity measured at 90% of tip radius, of about 1.0 to about 1.2. As used herein, the term “about” encompasses the stated value or range of values, as well as variations or deviations from the stated value or range of values that do not significantly affect aerodynamic behavior compared to the stated value or range of values, and/or are caused by errors in measurement, and/or are caused by variation in manufacturing processes

Another representative location is at 60% of the radial distance from the axial centerline to the tip, also referred to herein as “60% of tip radius”. For example, the fan 514 may have a solidity measured at 60% of tip radius, of less than about 1.6 and greater than about 1.0. As another example, the fan 514 may have a solidity, measured at 60% of tip radius, of no greater than about 1.4.

Another representative location is at 30% of the radial distance from the axial centerline to the tip, also referred to herein as “30% of tip radius”. For example, the fan 514 may have a solidity, measured at 30% of the radial distance from the root to the tip, of less than about 2.2 and greater than about 1.0. As another example, the fan 514 may have a solidity, measured at 30% of tip radius, of no greater than about 1.9.

It has been further found that consideration of the ratio of solidity to relative Mach number (abbreviated “Mᵣₑₗ”) at locations inboard of the tip is also useful in improving efficiency. It will be understood that the relative Mach number will vary during operation of the engine 510 depending on the phase of operation (e.g. idle, takeoff, climb, cruise, approach, landing) as well as prevailing atmospheric conditions. When the term Mach number or relative Mach number is discussed herein, it will be understood that this refers to a value that is selected to be significant for design purposes. For example, the Mach number considered for design purposes may be a value representative of the expected Mach number at level cruise flight conditions. As used herein, “level cruise flight” refers to extended operation at a stabilized altitude and Mach number.

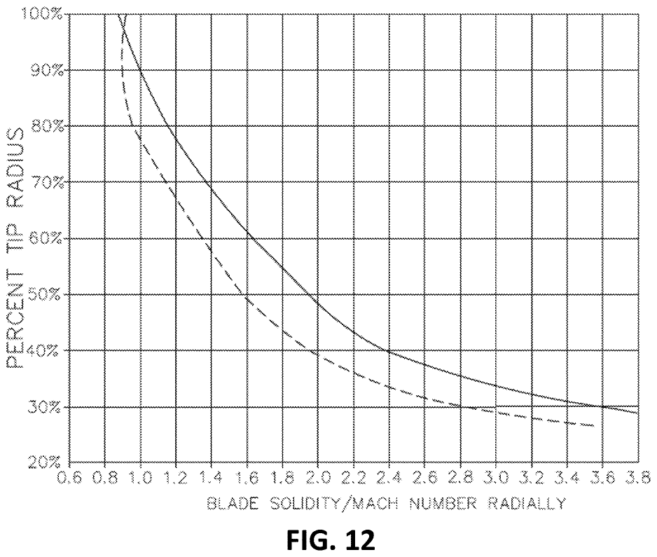

FIG. 12 illustrates the characteristics of the fan design according to an aspect of the present invention (shown in a dashed line) as compared to a prior art design (shown in a solid line). It can be seen that, while ratio of solidity to relative Mach number is close to 1.0 at the tip for both designs, the ratio of the fan 514 is lower at all locations inboard of the tip. The offset graph describing the lowered ratio at inboard locations may be characterized by the solidity/Mᵣₑₗ values at representative locations along the span.

One representative location is at 90% of tip radius. For example, given a predetermined relative Mach number, the solidity may be selected such that the ratio solidity/Mᵣₑₗ is less than about 0.90. As another example, the solidity of the may be set, given a predetermined relative Mach number, such that the ratio solidity/Mᵣₑₗ is no greater than about 0.87.

Another representative location is at 60% of tip radius. For example, given a predetermined relative Mach number Mᵣₑₗ, the fan 514 may have a ratio solidity/Mᵣₑₗ, measured at 60% of tip radius, of less than about 1.50 and greater than about 0.9. As another example, the fan 514 may have a ratio solidity/Mrel, measured at 60% of tip radius, of about 1.35 or less.

Another representative location is at 30% of tip radius. For example, given a predetermined relative Mach number Mᵣₑₗ, the fan 514 may have a ratio solidity/Mᵣₑₗ, measured at 30% radius, of less than about 3.20 and greater than about 0.9. As another example, the fan 514 may have a ratio solidity/Mᵣₑₗ, measured at 30% of tip radius, of about 2.81 or less.

Any of the fans 514 described above may be designed in part by establishing a predetermined relative Mach number at a specific radial location, and then given that predetermined relative Mach number, selecting a chord of the fan blades 532 at the specific radial location, to result in the desired ratio of the solidity to the relative Mach number. The low solidity turbofan described above may be used in various designs of turbofan aircraft gas turbine engines for improving efficiency thereof. Particular advantage is obtained for relatively large diameter transonic turbofans in which the blade tips are operated with supersonic airflow. Analysis of the fans described herein has confirmed an increase in aerodynamic efficiency thereof as compared to previous designs, while maintaining adequate stability and stall margin. The reduced blade count correspondingly reduces engine weight and cost.

Further aspects are provided by the subject matter of the following clauses:

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{Fan \_ LE} ⨯ {R}_{Hub \_ TE}}{{R}_{Fan \_ TE} ⨯ {R}_{Hub \_ LE}} .$$

The gas turbine engine of any preceding clause, wherein the FLTCF is greater than or equal to 1.07 and less than or equal to 1.65.

The gas turbine engine of any preceding clause, wherein the bypass ratio is greater than or equal to 13 and less than or equal to 25.

The gas turbine engine of any preceding clause, wherein the turbomachine comprises a compressor section having a low pressure compressor and a high pressure compressor, wherein the low pressure compressor is rotatable with the drive turbine.

The gas turbine engine of any preceding clause, further comprising: an outer nacelle surrounding at least in part the fan.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, and wherein the fan defines a fan blade count greater than or equal to 5 and less than or equal to 15.

The gas turbine engine of any preceding clause, wherein the FLTCF is greater than or equal to 1.07 and less than or equal to 1.25.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

The gas turbine engine of any preceding clause, wherein the FLTCF is greater than or equal to 1.12 and less than or equal to 1.35.

The gas turbine engine of any preceding clause, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{Fan \_ LE} - {R}_{Hub \_ LE}}{{R}_{Fan \_ TE} - {R}_{Hub \_ TE}} .$$

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{Fan \_ LE} - {R}_{Hub \_ LE}}{{R}_{Fan \_ TE} - {R}_{Hub \_ TE}} .$$

The gas turbine engine of any preceding clause, wherein the FLTOR is greater than or equal to 1.05 and less than or equal to 1.3.

The gas turbine engine of any preceding clause, wherein the bypass ratio is greater than or equal to 13 and less than or equal to 25.

The gas turbine engine of any preceding clause, further comprising: an outer nacelle surrounding at least in part the fan.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, wherein the fan defines a fan blade count greater than or equal to 5 and less than or equal to 15, and wherein the FLTOR is greater than or equal to 1.05 and less than or equal to 1.2.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio between 2:1 and 4:1, and wherein the FLTOR is greater than or equal to 1.07 and less than or equal to 1.18.

The gas turbine engine of any preceding clause, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{Fan \_ LE} \times {R}_{Hub \_ TE}}{{R}_{Fan \_ TE} \times {R}_{Hub \_ LE}} .$$

The gas turbine engine of any preceding clause, wherein the fan is an unducted fan, wherein the leading edge fan radius R_{Fan_LE} is greater than or equal to 65 inches and less than or equal to 85 inches, wherein the fan defines a fan blade count greater than or equal to 5 and less than or equal to 15, wherein the reduction gearbox defines a gear ratio greater than 4 and less than 12, wherein a thrust rating for the gas turbine engine is between 20,000 pounds and 45,000 pounds, wherein the FLTCF is greater than or equal to 1.07 and less than or equal to 1.25, and wherein the FLTOR is greater than or equal to 1.03 and less than or equal to 1.12.

The gas turbine engine of any preceding clause, wherein the fan is a ducted fan, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio greater than 2 and less than 4, wherein a thrust rating for the gas turbine engine is between 20,000 pounds and 45,000 pounds, wherein the FLTCF is greater than or equal to 1.12 and less than or equal to 1.35, and wherein the FLTOR is greater than or equal to 1.06 and less than or equal to 1.19.

The gas turbine engine of any preceding clause, wherein the fan is a ducted fan, wherein the leading edge fan radius R_{Fan_LE} is greater than or equal to 51 inches and less than or equal to 66 inches, wherein the fan defines a fan blade count greater than or equal to 17 and less than or equal to 23, wherein a thrust rating for the gas turbine engine is between 60,000 pounds and 118,000 pounds, wherein the FLTCF is greater than or equal to 1.27 and less than or equal to 1.5, and wherein the FLTOR is greater than or equal to 1.18 and less than or equal to 1.5.

The gas turbine engine of any preceding clause, wherein the fan is a ducted fan, wherein the leading edge fan radius R_{Fan_LE} is greater than or equal to 55 inches and less than or equal to 70 inches, wherein the fan defines a fan blade count greater than or equal to 12 and less than or equal to 22, wherein a thrust rating for the gas turbine engine is between 100,000 pounds and 150,000 pounds, wherein the FLTCF is greater than or equal to 1.46 and less than or equal to 1.65, and wherein the FLTOR is greater than or equal to 1.2 and less than or equal to 1.5.

A gas turbine engine defining a radial direction, the gas turbine engine comprising: a turbomachine comprising a drive turbine and defining a working gas flowpath and an inlet to the working gas flowpath; a fan with a plurality of fan blades with a solidity less than 1.6 and greater than 1.0, wherein the solidity is defined by a ratio of an airfoil chord length to a circumferential pitch of the fan blades, wherein the airfoil chord length is measured at 60% of a radial distance from an axial centerline of the fan to a tip of a fan blade of the plurality of fan blades, wherein a fan blade, of the plurality of fan blades, is formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{LE}} \times {R}_{{Hub}_{TE}}}{{R}_{{Fan}_{TE}} \times {R}_{{Hub}_{LE}}} .$$

The gas turbine engine of the preceding clause, wherein the FLTCF is greater than or equal to 1.07 and less than or equal to 1.65.

The gas turbine engine of any of the two preceding clauses, wherein the bypass ratio is greater than or equal to 13 and less than or equal to 25.

The gas turbine engine of any of the three preceding clauses, wherein the turbomachine comprises a compressor section having a low pressure compressor and a high pressure compressor, wherein the low pressure compressor is rotatable with the drive turbine.

The gas turbine engine of any of the four preceding clauses, further comprising an outer nacelle surrounding at least in part the fan.

The gas turbine engine of any of the five preceding clauses, wherein the fan is an unducted fan.

The gas turbine engine of any of the six preceding clauses, wherein the leading edge fan radius R_{Fan_LE} is greater than or equal to 65 inches and less than or equal to 85 inches, and wherein the fan defines a fan blade count greater than or equal to 5 and less than or equal to 15.

The gas turbine engine of any of the seven preceding clauses, wherein the FLTCF is greater than or equal to 1.07 and less than or equal to 1.25.

The gas turbine engine of any of the eight preceding clauses, wherein the leading edge fan radius R_{Fan_LE} is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

The gas turbine engine of any of the nine preceding clauses, wherein the FLTCF is greater than or equal to 1.12 and less than or equal to 1.35.

The gas turbine engine of any of the ten preceding clauses, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} .$$

A gas turbine engine defining a radial direction, the gas turbine engine comprising: a turbomachine comprising a drive turbine and defining a working gas flowpath and an inlet to the working gas flowpath; a fan with a plurality of fan blades with a solidity less than 1.6 and greater than 1.0, wherein the solidity is defined by a ratio of an airfoil chord length to a circumferential pitch of the fan blades, wherein the airfoil chord length is measured at 60% of a radial distance from an axial centerline of the fan to a tip of a fan blade of the plurality of fan blades; wherein the fan blade is formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} .$$

The gas turbine engine of the preceding clause, wherein the FLTOR is greater than or equal to 1.05 and less than or equal to 1.3.

The gas turbine engine of any of the two preceding clauses, wherein the bypass ratio is greater than or equal to 13 and less than or equal to 25.

The gas turbine engine of any of the three preceding clauses, further comprising: an outer nacelle surrounding at least in part the fan.

The gas turbine engine of any of the four preceding clauses, wherein the fan is an unducted fan.

The gas turbine engine of any of the five preceding clauses, wherein the leading edge fan radius R_{Fan_LE} is greater than or equal to 65 inches and less than or equal to 85 inches, wherein the fan defines a fan blade count greater than or equal to 5 and less than or equal to 15, and wherein the FLTOR is greater than or equal to 1.05 and less than or equal to 1.2.

The gas turbine engine of any of the six preceding clauses, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio between 2:1 and 4:1, and wherein the FLTOR is greater than or equal to 1.07 and less than or equal to 1.18.

The gas turbine engine of any of the seven preceding clauses, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{LE}} \times {R}_{{Hub}_{TE}}}{{R}_{{Fan}_{TE}} \times {R}_{{Hub}_{LE}}} .$$

The gas turbine engine of any of the eight preceding clauses, wherein the fan is an unducted fan, wherein the leading edge fan radius R_{Fan_LE} is greater than or equal to 65 inches and less than or equal to 85 inches, wherein the fan defines a fan blade count greater than or equal to 5 and less than or equal to 15, wherein the reduction gearbox defines a gear ratio greater than 4 and less than 12, wherein a thrust rating for the gas turbine engine is between 20,000 pounds and 45,000 pounds, wherein the FLTCF is greater than or equal to 1.07 and less than or equal to 1.25, and wherein the FLTOR is greater than or equal to 1.03 and less than or equal to 1.12.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

A gas turbine engine defining a radial direction, the gas turbine engine comprising: a turbomachine comprising a drive turbine and defining a working gas flowpath and an inlet to the working gas flowpath; a fan with a plurality of fan blades with a solidity between 1.0 and 1.2 in a blade tip region of the fan blades, wherein the solidity is defined as a ratio of an airfoil chord length to a circumferential pitch of the fan blades, wherein a fan blade, of the plurality of fan blades, is formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{LE}} \times {R}_{{Hub}_{TE}}}{{R}_{{Fan}_{TE}} \times {R}_{{Hub}_{LE}}} .$$

The gas turbine engine of the preceding clause, wherein the FLTCF is greater than or equal to 1.07 and less than or equal to 1.65.

The gas turbine engine of any of the two preceding clauses, wherein the bypass ratio is greater than or equal to 13 and less than or equal to 25.

The gas turbine engine of any of the three preceding clauses, wherein the turbomachine comprises a compressor section having a low pressure compressor and a high pressure compressor, wherein the low pressure compressor is rotatable with the drive turbine.

The gas turbine engine of any of the four preceding clauses, further comprising an outer nacelle surrounding at least in part the fan.

The gas turbine engine of any of the five preceding clauses, wherein the fan is an unducted fan.

The gas turbine engine of any of the six preceding clauses, wherein the leading edge fan radius R_{Fan_LE} is greater than or equal to 65 inches and less than or equal to 85 inches, and wherein the fan defines a fan blade count greater than or equal to 5 and less than or equal to 15.

The gas turbine engine of any of the seven preceding clauses, wherein the FLTCF is greater than or equal to 1.07 and less than or equal to 1.25.

The gas turbine engine of any of the eight preceding clauses, wherein the leading edge fan radius R_{Fan_LE} is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

The gas turbine engine of any of the nine preceding clauses, wherein the FLTCF is greater than or equal to 1.12 and less than or equal to 1.35.

The gas turbine engine of any of the ten preceding clauses, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} .$$

A gas turbine engine defining a radial direction, the gas turbine engine comprising: a turbomachine comprising a drive turbine and defining a working gas flowpath and an inlet to the working gas flowpath; a fan with a plurality of fan blades with a solidity between 1.0 and 1.2 in a blade tip region of the fan blades, wherein the solidity is defined as a ratio of an airfoil chord length to a circumferential pitch of the fan blades, wherein a fan blade, of the plurality of fan blades, is formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} .$$

The gas turbine engine of the preceding clause, wherein the FLTOR is greater than or equal to 1.05 and less than or equal to 1.3.

The gas turbine engine of any of the two preceding clauses, wherein the bypass ratio is greater than or equal to 13 and less than or equal to 25.

The gas turbine engine of any of the three preceding clauses, further comprising: an outer nacelle surrounding at least in part the fan.

The gas turbine engine of any of the four preceding clauses, wherein the fan is an unducted fan.

The gas turbine engine of any of the five preceding clauses, wherein the leading edge fan radius R_{Fan_LE} is greater than or equal to 65 inches and less than or equal to 85 inches, wherein the fan defines a fan blade count greater than or equal to 5 and less than or equal to 15, and wherein the FLTOR is greater than or equal to 1.05 and less than or equal to 1.2.

The gas turbine engine of any of the six preceding clauses, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio between 2:1 and 4:1, and wherein the FLTOR is greater than or equal to 1.07 and less than or equal to 1.18.

The gas turbine engine of any of the seven preceding clauses, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{LE}} \times {R}_{{Hub}_{TE}}}{{R}_{{Fan}_{TE}} \times {R}_{{Hub}_{LE}}} .$$

The gas turbine engine of any of the eight preceding clauses, wherein the fan is an unducted fan, wherein the leading edge fan radius R_{Fan_LE} is greater than or equal to 65 inches and less than or equal to 85 inches, wherein the fan defines a fan blade count greater than or equal to 5 and less than or equal to 15, wherein the reduction gearbox defines a gear ratio greater than 4 and less than 12, wherein a thrust rating for the gas turbine engine is between 20,000 pounds and 45,000 pounds, wherein the FLTCF is greater than or equal to 1.07 and less than or equal to 1.25, and wherein the FLTOR is greater than or equal to 1.03 and less than or equal to 1.12.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A gas turbine engine defining a radial direction, the gas turbine engine comprising:
a turbomachine comprising a drive turbine and defining a working gas flowpath and an inlet to the working gas flowpath;
a fan with a plurality of fan blades with a solidity less than 1.6 and greater than 1.0, wherein the solidity is defined by a ratio of an airfoil chord length to a circumferential pitch of the fan blades, wherein the airfoil chord length is measured at 60% of a radial distance from an axial centerline of the fan to a tip of a fan blade of the plurality of fan blades,
wherein a fan blade, of the plurality of fan blades, is formed of a composite material,
the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and
a reduction gearbox mechanically coupling the drive turbine of the turbomachine to the fan;
wherein the gas turbine engine defines a Fan Leading Edge to Trailing Edge Compression Factor (FLTCF) greater than or equal to 1.05 and less than or equal to 1.8, the FLTCF being equal to:
$$\frac{{R}_{{Fan}_{LE}} \times {R}_{{Hub}_{TE}}}{{R}_{{Fan}_{TE}} \times {R}_{{Hub}_{LE}}} .$$

2. The gas turbine engine of claim 1, wherein the FLTCF is greater than or equal to 1.07 and less than or equal to 1.65.

3. The gas turbine engine of claim 1, wherein the bypass ratio is greater than or equal to 13 and less than or equal to 25.

4. The gas turbine engine of claim 1, wherein the turbomachine comprises a compressor section having a low pressure compressor and a high pressure compressor, wherein the low pressure compressor is rotatable with the drive turbine.

5. The gas turbine engine of claim 1, further comprising:
an outer nacelle surrounding at least in part the fan.

6. The gas turbine engine of claim 1, wherein the fan is an unducted fan.

7. The gas turbine engine of claim 6, wherein the leading edge fan radius R_{Fan_LE} is greater than or equal to 65 inches and less than or equal to 85 inches, and wherein the fan defines a fan blade count greater than or equal to 5 and less than or equal to 15.

8. The gas turbine engine of claim 6, wherein the FLTCF is greater than or equal to 1.07 and less than or equal to 1.25.

9. The gas turbine engine of claim 1, wherein the leading edge fan radius R_{Fan_LE} is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

10. The gas turbine engine of claim 9, wherein the FLTCF is greater than or equal to 1.12 and less than or equal to 1.35.

11. The gas turbine engine of claim 1, wherein the gas turbine engine defines a Fan Leading Edge to Trailing Edge Opening Ratio (FLTOR) greater than or equal to 1.03 and less than or equal to 1.5, the FLTOR being equal to:
$$\frac{{R}_{{Fan}_{LE}} - {R}_{{Hub}_{LE}}}{{R}_{{Fan}_{TE}} - {R}_{{Hub}_{TE}}} .$$

12. A gas turbine engine defining a radial direction, the gas turbine engine comprising:
a turbomachine comprising a drive turbine and defining a working gas flowpath and an inlet to the working gas flowpath;
a fan with a plurality of fan blades with a solidity less than 1.6 and greater than 1.0, wherein the solidity is defined by a ratio of an airfoil chord length to a circumferential pitch of the fan blades, wherein the airfoil chord length is measured at 60% of a radial distance from an axial centerline of the fan to a tip of a fan blade of the plurality of fan blades;
wherein the fan blade is formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and
a reduction gearbox mechanically coupling the drive turbine of the turbomachine to the fan;
wherein the gas turbine engine defines a Fan Leading Edge to Trailing Edge Opening Ratio (FLTOR) greater than or equal to 1.03 and less than or equal to 1.5, the FLTOR being equal to:
$$\frac{{R}_{{Fan}_{LE}} - {R}_{{Hub}_{LE}}}{{R}_{{Fan}_{TE}} - {R}_{{Hub}_{TE}}} .$$

13. The gas turbine engine of claim 12, wherein the FLTOR is greater than or equal to 1.05 and less than or equal to 1.3.

14. The gas turbine engine of claim 12, wherein the bypass ratio is greater than or equal to 13 and less than or equal to 25.

15. The gas turbine engine of claim 12, further comprising:
an outer nacelle surrounding at least in part the fan.

16. The gas turbine engine of claim 12, wherein the fan is an unducted fan.

17. The gas turbine engine of claim 16, wherein the leading edge fan radius R_{Fan_LE} is greater than or equal to 65 inches and less than or equal to 85 inches, wherein the fan defines a fan blade count greater than or equal to 5 and less than or equal to 15, and wherein the FLTOR is greater than or equal to 1.05 and less than or equal to 1.2.

18. The gas turbine engine of claim 12, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio between 2:1 and 4:1, and wherein the FLTOR is greater than or equal to 1.07 and less than or equal to 1.18.

19. The gas turbine engine of claim 12, wherein the gas turbine engine defines a Fan Leading Edge to Trailing Edge Compression Factor (FLTCF) greater than or equal to 1.05 and less than or equal to 1.8, the FLTCF being equal to:
$$\frac{{R}_{{Fan}_{LE}} \times {R}_{{Hub}_{TE}}}{{R}_{{Fan}_{TE}} \times {R}_{{Hub}_{LE}}} .$$

20. The gas turbine engine of claim 19, wherein the fan is an unducted fan, wherein the leading edge fan radius R_{Fan_LE} is greater than or equal to 65 inches and less than or equal to 85 inches, wherein the fan defines a fan blade count greater than or equal to 5 and less than or equal to 15, wherein the reduction gearbox defines a gear ratio greater than 4 and less than 12, wherein a thrust rating for the gas turbine engine is between 20,000 pounds and 45,000 pounds, wherein the FLTCF is greater than or equal to 1.07 and less than or equal to 1.25, and wherein the FLTOR is greater than or equal to 1.03 and less than or equal to 1.12.
